(19) United States
(12) Patent Application Publication
(10) Pub. No.: US 2008/0252721 A1
(43) Pub. Date: Oct. 16, 2008

(54) Film detection device and method, and picture signal processing device and method

(75) Inventor: Yoshito Suzuki, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/078,494

(22) Filed: Apr. 1, 2008

(30) Foreign Application Priority Data
Apr. 16, 2007 (JP) 2007-107078

(51) Int. Cl. H04N 3/36

(52) U.S. Cl. 348/97; 348/E03.002

(57) ABSTRACT

Disclosed herein is a film detection device for determining whether an input picture signal is an interlaced signal generated by the telecine process, the film detection device including, a frame motion detection section, a field motion detection section, a motion judder detection section, and a film determination section.

### CROSS REFERENCES TO RELATED APPLICATIONS

The present invention contains subject matter related to Japanese Patent Application JP 2007-107078 filed in the Japan Patent Office on Apr. 16, 2007, the entire contents of which being incorporated herein by reference.

### BACKGROUND OF THE INVENTION

1. Field of the Invention

The present invention relates to a film detection device and method for films having pictures recorded thereon, and to a picture signal processing device and method.

2. Description of the Related Art

The term “telecine process” refers to the process by which a picture recorded on a film such as movie film is converted into a television signal for broadcasting or other purposes. The telecine process normally converts the frame rate. At the same time, the telecine process splits each frame of the film into two fields because an interlaced signal is primarily used for broadcasting.

The 2:2 pulldown and 3:2 pulldown techniques are popular as the telecine system. The 2:2 pulldown technique is employed when the television signal's field frequency is close to twice the film frame rate. Here, this technique provides an interlaced signal by dividing each frame of the film into two fields, one field made up of only even lines and the other made up of only odd lines of the frame.

In contrast, the 3:2 pulldown technique is used when the television signal's field frequency is close to 2.5 times the film frame rate. The 3:2 pulldown technique provides an interlaced signal by dividing each frame of the film in the same manner as the 2:2 pulldown technique for the first four fields of the television signal and repeating the third field for the fifth field of the television signal.

It should be noted that a pulldown technique other than the above may be employed depending on the combination of television signal's field frequency and film frame rate.

On the television signal receiving side, a picture signal obtained from the telecine process (hereinafter referred to as a “telecine material”) may need to be distinguished from a picture signal captured by an ordinary television camera (hereinafter referred to as a “video material”).

One example of such a case is that a television set employs different schemes to perform de-interlacing of telecine and video materials.

In addition to the above, a picture recording device may detect 3:2 pulldown to remove in advance the field identical in content which appears once every five fields prior to compression and recording of a moving image. In the description given below, the detection of a pulldown picture signal such as 3:2 and 2:2 pulldown detection will be collectively referred to as “film detection.”

An example of the 3:2 pulldown detection method is given in Japanese Patent No. 2870565 hereinafter referred to as Patent Document 1. The 3:2 pulldown detection relies on the fact that the field image identical in content appears every five fields as described above.

A calculation of the difference between an input picture signal and a picture signal delayed by two fields from the input picture signal reveals that the difference is smaller once every five fields for a 3:2 pulldown picture signal. This is not likely to occur with a video material. As a result, 3:2 pulldown can be detected by monitoring a periodic change of the difference between the signals distant from each other by two fields.

On the other hand, an example of the 2:2 pulldown detection method is given in U.S. Pat. No. 6,580,463 hereinafter referred to as Patent Document 2. The detection method in Patent Document 1 relies on the difference between the signals distant from each other by two fields. In contrast, the method in Patent Document 2 calculates the difference between an input picture signal and a picture signal delayed by one field from the input signal.

With a telecine material, the difference between two field images derived from the same film frame is expected to be smaller than that between two field images derived from different film frames. In the case of a 2:2 pulldown picture signal input, therefore, the field-to-field difference alternates between large and small values every field.

It should be noted that the 2:2 pulldown detection method disclosed in Patent Document 2 can also detect 3:2 pulldown with a common circuit. A calculation of the field-to-field difference for a 3:2 pulldown picture signal reveals that the field-to-field difference alternates between large and small values every field for the first four fields as with 2:2 pulldown. For the last field, the two field images derived from the same film frame are compared. As a result, the field-to-field difference is small.

Thus, if the field-to-field difference changes from large to small to large to small and small values in this order at intervals of five fields, the input picture signal can be considered to be a 3:2 pulldown signal.

Further, the detection method disclosed in Patent Document 2 can detect edit points in a telecine material without delay. One of the two field images derived from the same film frame may be lost near an edit point.

In de-interlacing in particular, the original film frame cannot be restored by simple overlaying of fields. As a result, the detection of edit points is needed. With an ordinary telecine material, the field-to-field difference is never large for two consecutive fields. In this case, therefore, we can assume that the input picture signal has been changed to a video material by editing.

Among examples of particular telecine materials is a picture signal containing telecine and video materials in the same field image (hereinafter referred to as a “hybrid material”).

Japan Patent No. 3389984 (hereinafter referred to as Patent Document 3) describes a technique to choose a de-interlacing method which is as probable as possible even in such a case. Here, the picture signal for each pixel is determined to be a telecine or video material using the field-to-field difference so that a proper de-interlacing scheme is selected.

That is, the local differences in pixel value are compared between the current, previous and next fields. If the difference is small only in one of the fields, de-interlacing suitable for a telecine material is performed in this area.

### SUMMARY OF THE INVENTION

The scheme described in Patent Document 1 performs detection at intervals of five fields, resulting in slow detection. In particular, if the input picture signal changes from a telecine to video material or vice versa, this change can be detected five fields later in the worst case. If film detection is used for de-interlacing, slow detection is apt to lead to degraded image quality due to erroneous de-interlacing. Moreover, this scheme is disadvantageous in that it can only detect 3:2 pulldown.

On the other hand, the scheme described in Patent Document 2 is advantageous in that it can detect not only both 3:2 and 2:2 pulldown but also edit points. However, the scheme has drawbacks. That is, the scheme is slow to detect the change of the input picture signal from a video material to telecine material. The scheme is less accurate than the scheme in Patent Document 1 in detecting 3:2 pulldown.

First, the reason for slow detection of the change from a video material to telecine material will be described. Even in a video material, the field-to-field difference may be different between two consecutive fields. To positively detect a telecine material, therefore, it is necessary to monitor a periodic change of the field-to-field difference over a more or less long period of time (e.g., four fields or more).

Further, the detection accuracy for 3:2 pulldown is low because of the following reason. That is, the scheme described in Patent Document 1 finds the two-field difference. As a result, this scheme calculates the difference between even lines or between odd lines of the film frame. On the other, the scheme described in Patent Document 2 finds the field-to-field difference. As a result, this scheme calculates the difference between even and odd lines. If we assume that the original film frame contains a vertical high frequency component, even and odd lines of a field image derived from the same film frame do not always have exactly the same content.

The scheme described in Patent Document 1 compares even or odd lines. Even in the above case, therefore, the field identical in content which appears once every five fields can be properly detected. However, even if a field appears which is identical in content to the field preceding the previous field, the scheme described in Patent Document 2 may detect a large field-to-field difference, possibly resulting in erroneous detection of 3:2 pulldown. The difference between field images derived from the same film frame is not always small. Therefore, a similar erroneous detection may occur in the detection of 2:2 pulldown.

The scheme described in Patent Document 3 relies only on the local difference between field images for detection. On one hand, this provides two advantages, namely, quick response and capability to detect an arbitrary pulldown sequence which includes a hybrid material. On the other hand, the scheme has a drawback that erroneous detection is apt to occur for an image containing many vertical high frequency components. The scheme described in Patent Document 2 does not fail in film detection at least for an image locally containing many vertical high frequency components. Therefore, the scheme in Patent Document 3 is more prone to erroneous detection than that in Patent Document 2.

According to embodiments of the present invention, it is provided a film detection device and method which is capable of detecting a telecine material having an arbitrary pulldown sequence using a common circuit and which is also capable of handling picture edit points and hybrid materials thanks to high detection accuracy coupled with quick response. It is also another embodiment of the present invention to provide a picture signal processing device and method using the film detection device and method.

According to an embodiment of the present invention, it is provided a film detection device for determining whether an input picture signal is an interlaced signal generated by the telecine process, the film detection device including:

frame motion detection means for detecting, as a scalar or vector value, a frame-to-frame picture motion between previous and next fields, the previous field being a field preceding a current field, and the next field being a field succeeding the current field;

field motion detection means for detecting, as a scalar or vector value, a field-to-field picture motion between the current and previous or next fields;

motion judder detection means for calculating the probability that there is a picture motion between frames while there is no picture motion between fields using at least the detection results of the frame motion detection means and field motion detection means; and

film determination means for calculating the probability that the input picture signal is an interlaced signal generated by the telecine process using at least the detection result of the motion judder detection means.

According to an embodiment of the present invention, it is provided a film detection device for determining whether an input picture signal is an interlaced signal generated by the telecine process, the film detection device including:

frame motion detection means for detecting, as a scalar or vector value, a frame-to-frame picture motion between previous and next fields, the previous field being a field preceding a current field, and the next field being a field succeeding the current field;

first field motion detection means for detecting, as a scalar or vector value, a field-to-field picture motion between the current and next fields;

second field motion detection means for detecting, as a scalar or vector value, a field-to-field picture motion between the current and previous fields;

first motion judder detection means for calculating the probability that there is a picture motion between frames while there is no picture motion between fields using at least the detection results of the frame motion detection means and first field motion detection means;

second motion judder detection means for calculating the probability that there is a picture motion between frames while there is no picture motion between fields using at least the detection results of the frame motion detection means and second field motion detection means; and

film determination means for calculating the probability that the input picture signal is an interlaced signal generated by the telecine process using at least the detection results of the first and second motion judder detection means.

According to an embodiment of the present invention, it is provided a film detection device for determining whether an input picture signal is an interlaced signal generated by the telecine process, the film detection device including:

first delaying means adapted to delay the input picture signal by one field;

second delaying means adapted to delay the input picture signal by two fields;

frame motion detection means for detecting, as a scalar or vector value, a frame-to-frame picture motion using the input picture signal and an output picture signal of the second delaying means;

first field motion detection means for detecting, as a scalar or vector value, a field-to-field picture motion using the input picture signal and an output picture signal of the first delaying means;

second field motion detection means for detecting, as a scalar or vector value, a field-to-field picture motion using the input picture signal and the output picture signal of the second delaying means;

first motion judder detection means for calculating the probability that there is a picture motion between frames while there is no picture motion between fields using at least the detection results of the frame motion detection means and first field motion detection means;

second motion judder detection means for calculating the probability that there is a picture motion between frames while there is no picture motion between fields using at least the detection results of the frame motion detection means and second field motion detection means;

first accumulation means for accumulating the detection result of the first motion judder detection means in the spatial direction;

second accumulation means for accumulating the detection result of the second motion judder detection means in the spatial direction;

first film determination means for determining the probability that the input picture signal is an interlaced signal generated by the telecine process for a global image area using at least the accumulation results of the first and second accumulation means; and

second film determination means for determining the probability that the input picture signal is an interlaced signal generated by the telecine process for a local image area which is part of the global image area using at least the detection result of the first field motion detection means or first motion judder detection means and the detection result of the second field motion detection means or second motion judder detection means.

According to an embodiment of the present invention, it is provided a film detection device for determining whether an input picture signal is an interlaced signal generated by the telecine process, the film detection device including:

first delaying means for delaying the input picture signal by one field;

second delaying means for delaying the input picture signal by two fields;

third delaying means for delaying the input picture signal by three fields;

frame motion detection means for detecting, as a scalar or vector value, a frame-to-frame picture motion using output picture signals of the first and third delaying means;

first field motion detection means for detecting, as a scalar or vector value, a field-to-field picture motion using the input picture signal and the output picture signal of the first delaying means;

second field motion detection means for detecting, as a scalar or vector value, a field-to-field picture motion using the output picture signal of the first delaying means and an output picture signal of the second delaying means;

third field motion detection means for detecting, as a scalar or vector value, a field-to-field picture motion using the output picture signals of the second and third delaying means;

first motion judder detection means for calculating the probability that there is a picture motion between frames while there is no picture motion between fields using at least the detection results of the frame motion detection means and first field motion detection means;

second motion judder detection means for calculating the probability that there is a picture motion between frames while there is no picture motion between fields using at least the detection results of the frame motion detection means and second field motion detection means;

first accumulation means for accumulating the detection result of the first motion judder detection means in the spatial direction;

second accumulation means for accumulating the detection result of the second motion judder detection means in the spatial direction;

first film determination means for determining the probability that the input picture signal is an interlaced signal generated by the telecine process for a global image area using at least the accumulation results of the first and second accumulation means; and

second film determination means for determining the probability that the input picture signal is an interlaced signal generated by the telecine process for a local image area which is part of the global image area using at least the detection results of the second and third field motion detection means.

According to an embodiment of the present invention, it is provided a picture signal processing device for converting an input picture signal, which is an interlaced signal, into a progressive signal, the picture signal processing device including:

frame motion detection means for detecting, as a scalar or vector value, a frame-to-frame picture motion between previous and next fields, the previous field being a field preceding a current field, and the next field being a field succeeding the current field;

field motion detection means for detecting, as a scalar or vector value, a field-to-field picture motion between the current and previous or next fields;

motion judder detection means for calculating the probability that there is a picture motion between frames while there is no picture motion between fields using at least the detection results of the frame motion detection means and field motion detection means; and

de-interlacing means for changing methods to convert the input picture signal into a progressive signal at least according to the detection result of the motion judder detection means.

According to an embodiment of the present invention, it is provided a film detection method for determining whether an input picture signal is an interlaced signal generated by the telecine process, the film detection method including the steps of:

detecting, as a scalar or vector value, a frame-to-frame picture motion M between previous and next fields, the previous field being a field preceding a current field, and the next field being a field succeeding the current field;

detecting, as a scalar or vector value, a field-to-field picture motion m between the current and previous or next fields;

calculating a probability J that there is a picture motion between frames while there is no picture motion between fields using at least the frame-to-frame picture motion M and field-to-field picture motion m; and

calculating the probability that the input picture signal is an interlaced signal generated by the telecine process using at least the probability J.

According to an embodiment of the present invention, it is provided a film detection method for determining whether an input picture signal is an interlaced signal generated by the telecine process, the film detection method including the steps of:

detecting, as a scalar or vector value, a frame-to-frame picture motion M between previous and next fields, the previous field being a field preceding a current field, and the next field being a field succeeding the current field;

detecting, as a scalar or vector value, a field-to-field picture motion m1 between the current and next fields;

detecting, as a scalar or vector value, a field-to-field picture motion m2 between the current and previous fields;

calculating a probability J1 that there is a picture motion between frames while there is no picture motion between fields using at least the frame-to-frame picture motion M and field-to-field picture motion m1;

calculating a probability J2 that there is a picture motion between frames while there is no picture motion between fields using at least the frame-to-frame picture motion M and field-to-field picture motion m2; and

calculating the probability that the input picture signal is an interlaced signal generated by the telecine process using at least the probabilities J1 and J2.

According to an embodiment of the present invention, it is provided a film detection method for determining whether an input picture signal is an interlaced signal generated by the telecine process, the film detection method including the steps of:

delaying the input picture signal by one field to obtain a one-field delayed signal;

delaying the input picture signal by two fields to obtain a two-field delayed signal;

detecting, as a scalar or vector value, a frame-to-frame picture motion M using the input picture signal and two-field delayed signal;

detecting, as a scalar or vector value, a field-to-field picture motion m1 using the input picture signal and one-field delayed signal;

detecting, as a scalar or vector value, a field-to-field picture motion m2 using the one-field and two-field delayed signals;

calculating a probability j1 that there is a picture motion between frames while there is no picture motion between fields using at least the frame-to-frame picture motion M and field-to-field picture motion m1;

calculating a probability j2 that there is a picture motion between frames while there is no picture motion between fields using at least the frame-to-frame picture motion M and field-to-field picture motion m2;

accumulating the probability j1 in the spatial direction to obtain an accumulated sum J1;

accumulating the probability j2 in the spatial direction to obtain an accumulated sum J2;

determining the probability that the input picture signal is an interlaced signal generated by the telecine process for a global image area using at least the accumulated sums J1 and J2; and

determining the probability that the input picture signal is an interlaced signal generated by the telecine process for a local image area which is part of the global image area using at least the field-to-field picture motion m1 or probability j1 and the field-to-field picture motion m2 or probability j2.

According to an embodiment of the present invention, it is provided a film detection method for determining whether an input picture signal is an interlaced signal generated by the telecine process, the film detection method including the steps of:

delaying the input picture signal by one field to obtain a one-field delayed signal;

delaying the input picture signal by two fields to obtain a two-field delayed signal;

delaying the input picture signal by three fields to obtain a three-field delayed signal;

detecting, as a scalar or vector value, a frame-to-frame picture motion M using the one-field and three-field delayed signals;

detecting, as a scalar or vector value, a field-to-field picture motion m1 using the input picture signal and one-field delayed signal;

detecting, as a scalar or vector value, a field-to-field picture motion m2 using the one-field and two-field delayed signals;

detecting, as a scalar or vector value, a field-to-field picture motion m3 using the two-field and three-field delayed signals;

calculating a probability j1 that there is a picture motion between frames while there is no picture motion between fields using at least the frame-to-frame picture motion M and field-to-field picture motion m1;

calculating a probability j2 that there is a picture motion between frames while there is no picture motion between fields using at least the frame-to-frame picture motion M and field-to-field picture motion m2;

accumulating the probability j1 in the spatial direction to obtain an accumulated sum J1;

accumulating the probability j2 in the spatial direction to obtain an accumulated sum J2;

determining the probability that the input picture signal is an interlaced signal generated by the telecine process for a global image area using at least the accumulated sums J1 and J2; and

determining the probability that the input picture signal is an interlaced signal generated by the telecine process for a local image area which is part of the global image area using at least the field-to-field picture motions m2 and m3.

According to an embodiment of the present invention, it is provided a picture signal processing method for converting an input picture signal, which is an interlaced signal, into a progressive signal, the picture signal processing method including the steps of:

detecting, as a scalar or vector value, a frame-to-frame picture motion M between previous and next fields, the previous field being a field preceding a current field, and the next-field being a field succeeding the current field;

detecting, as a scalar or vector value, a field-to-field picture motion m between the current and previous or next fields;

calculating a probability j that there is a picture motion between frames while there is no picture motion between fields using at least the frame-to-frame picture motion M and field-to-field picture motion m; and

changing methods to convert the input picture signal into a progressive signal at least according to the probability j.

The embodiments of the present invention allows for detection of a telecine material having an arbitrary pulldown sequence using a common circuit.

Further, the embodiments of the present invention offer both high detection accuracy and quick response to additionally allow detection of a picture edit point and hybrid material.

### BRIEF DESCRIPTION OF THE DRAWINGS

FIG. 1 is a view illustrating the overall configuration of a picture signal processing device according to a first embodiment of the present invention;

FIG. 2 is a view illustrating the internal configuration of a film determination circuit according to the present embodiment;

FIG. 3 is a view illustrating the internal configuration of a de-interlacing circuit according to the present embodiment;

FIG. 4 is a view 1 for describing the operation of the picture signal processing device according to the first embodiment;

FIG. 5 is a view 2 for describing the operation of the picture signal processing device according to the first embodiment;

FIG. 6 is a view 3 for describing the operation of the picture signal processing device according to the first embodiment;

FIG. 7 is a view 4 for describing the operation of the picture signal processing device according to the first embodiment;

FIG. 8 is a view 5 for describing the operation of the picture signal processing device according to the first embodiment;

FIG. 9 is a view illustrating the relationship between a mixing factor k2 and an output value F+j of an adder;

FIG. 10 is a view illustrating the telecine process using the 2:2 pulldown technique;

FIG. 11 is a view illustrating the image contents of the next, current and previous fields, the values of two registers incorporated in a shift register and a determination result F of the film determination circuit at different times;

FIG. 12 is a view illustrating the telecine process using the 3:2 pulldown technique;

FIG. 13 is a view illustrating the detection result of the film determination circuit for a telecine material obtained by the 3:2 pulldown technique;

FIG. 14 is a view illustrating switching between video and telecine materials;

FIG. 15 is a view illustrating the detection result of the film detection circuit in response to the input as shown in FIG. 14;

FIG. 16 is a view illustrating the overall configuration of the picture signal processing device according to a second embodiment of the present invention;

FIG. 17 is a view illustrating the internal configuration of the film determination circuit according to the second embodiment;

FIG. 18 is a view illustrating the internal configuration of the de-interlacing circuit according to the second embodiment;

FIG. 19 is a view illustrating the relationship between an absolute value D0 and a frame-to-frame picture motion M;

FIG. 20 is a view illustrating the overall configuration of the picture signal processing device according to a third embodiment of the present invention;

FIG. 21 is a view illustrating the internal configuration of the film determination circuit according to the third embodiment;

FIG. 22 is a view illustrating the internal configuration of a de-interlacing circuit 45 according to the third embodiment; and

FIG. 23 is a view illustrating the overall configuration of the picture signal processing device according to a fourth embodiment of the present invention.

### DETAILED DESCRIPTION OF THE PREFERRED EMBODIMENTS

The preferred embodiments of the present invention will be described below with reference to the accompanying drawings.

### First Embodiment

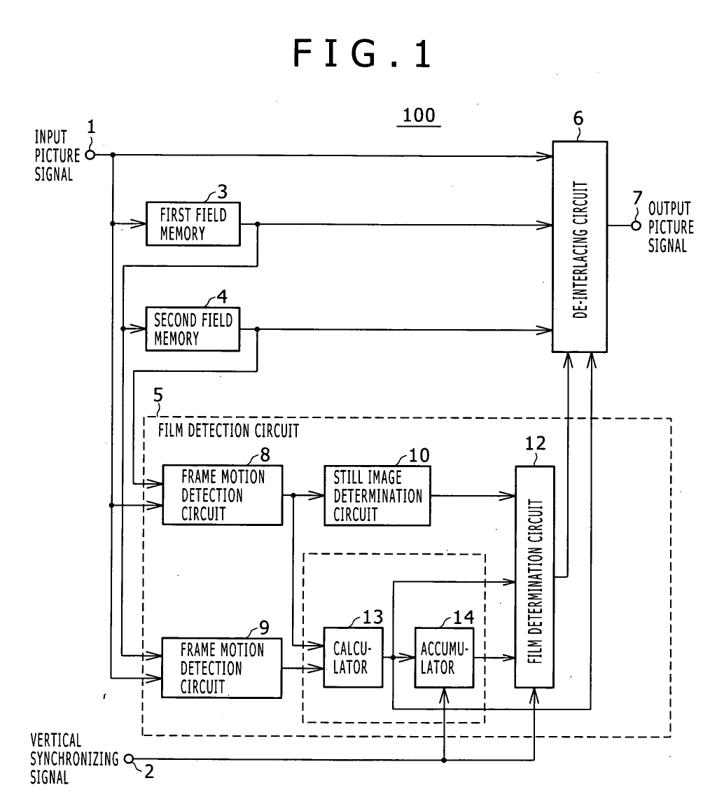

FIG. 1 is a view illustrating the overall configuration of a picture signal processing device according to a first embodiment of the present invention.

As illustrated in FIG. 1, a picture signal processing device 100 according to the first embodiment includes an input terminal 1 adapted to receive a picture signal, an input terminal 2 adapted to receive a vertical synchronizing signal, a first field memory 3 adapted to delay the picture signal received from the input terminal 1 by one field, a second field memory 4 adapted to delay the picture signal received from the input terminal 1 by two fields by delaying the picture signal already delayed one field by delaying one more field, a film detection circuit 5 adapted to determine the probability that the picture signal received from the input terminal 1 is an interlaced signal generated by the telecine process, a de-interlacing circuit 6 adapted to change de-interlacing methods according to the detection result of the film detection circuit 5, and an output terminal 7 adapted to output a progressive signal converted from the picture signal by the de-interlacing circuit 6.

Hereinafter, for simplicity, the output picture signal of the first field memory 3 will be referred to as the “current-field picture signal”, the picture signal received from the input terminal 1 the “next-field picture signal”, and the output picture signal of the second field memory 4 the “previous-field picture signal.” The previous field is a field preceding a current field. The next field is a field succeeding the current field.

The dotted line in FIG. 1 represents the film detection circuit 5. The area enclosed by the dotted line illustrates the internal configuration of the film detection circuit 5.

The film detection circuit 5 includes a frame motion detection circuit 8 adapted to detect a frame-to-frame picture motion using the next- and previous-field picture signals, a field motion detection circuit 9 adapted to detect a field-to-field picture motion using the current- and next-field picture signals, a still image determination circuit 10 adapted to detect that there is no picture motion between frames using the frame-to-frame picture motion detected by the frame motion detection circuit 8, The film detection circuit 5 still further includes a motion judder detection circuit 11 adapted to detect a judder in the picture motion (a judder in the picture motion will be hereinafter referred to as a “motion judder”). The frame-to-frame picture motion detected by the frame motion detection circuit 8 and field-to-field picture motion detected by the field motion detection circuit 9 are used to detect the judder, and a film determination circuit 12 adapted to determine the probability that the input picture signal received from the input terminal 1 is an interlaced signal generated by the telecine process.

The determination result of the film determination circuit 12 is updated each time a reference edge of a vertical synchronizing signal is received from the input terminal 2.

Further, the motion judder detection circuit 11 includes a calculator 13 and accumulator 14. The calculator 13 calculates a motion judder using a transform function which will be described later. The function has a frame-to-frame motion and field-to-field motion as variables. The accumulator 14 accumulates the motion judder, calculated by the calculator 13, in the spatial direction. The accumulator 14 resets the accumulation result to 0 each time a reference edge of a vertical synchronizing signal is received from the input terminal 2.

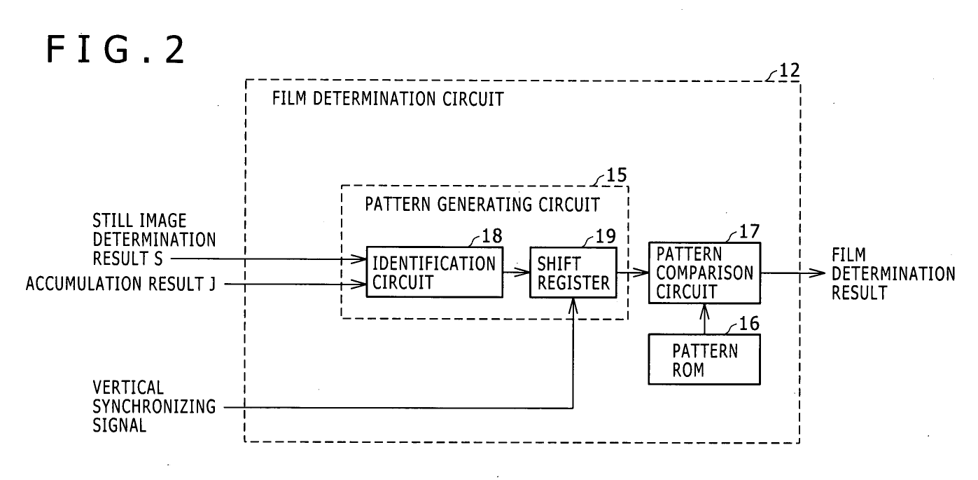

FIG. 2 is a view illustrating the internal configuration of the film determination circuit 12 according to the present embodiment.

As illustrated in FIG. 2, the film determination circuit 12 includes a pattern generating circuit 15 adapted to generate a finite and discrete number of patterns using the time series of the determination result of the still image determination circuit 10 and that of the accumulation result of the accumulator 14, a pattern ROM 16 adapted to store patterns to be compared with a pattern generated by the pattern generating circuit 15, and a pattern comparison circuit 17 adapted to compare a pattern generated by the pattern generating circuit 15 with one of the patterns stored in the pattern ROM 16 to find a match.

Further, the pattern generating circuit 15 includes an identification circuit 18 adapted to identify the status of a picture signal based on the determination result of the still image determination circuit 10 and the accumulation result of the accumulator 14, a shift register 19 adapted to store the identification result of the identification circuit 18 for a plurality of fields.

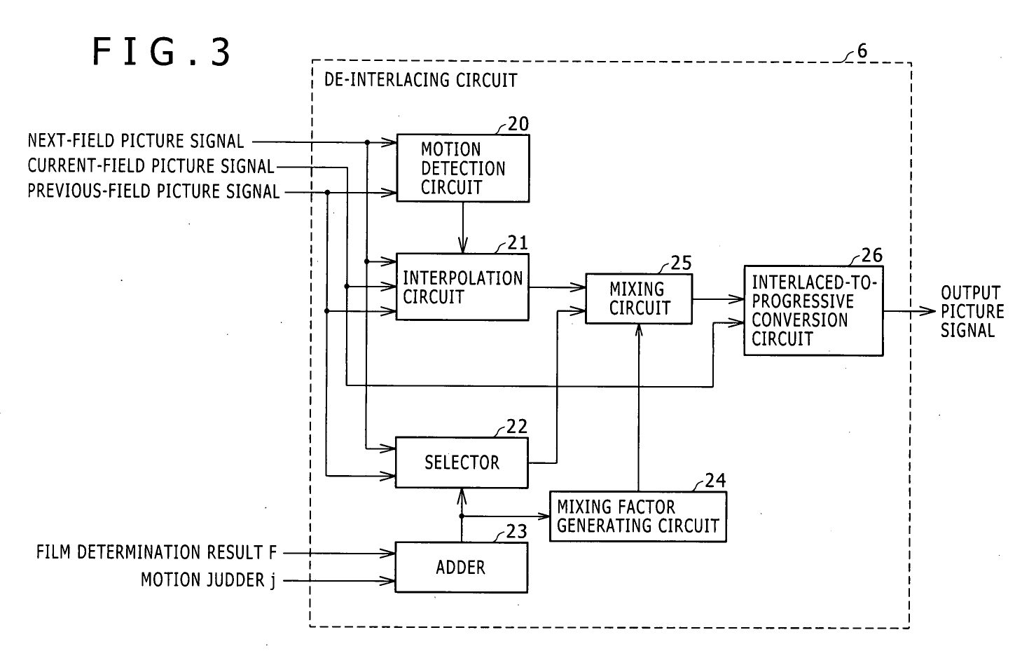

FIG. 3 is a view illustrating the internal configuration of the de-interlacing circuit 6 according to the present embodiment.

In FIG. 3, the de-interlacing circuit 6 includes a motion detection circuit 20 adapted to generate a motion factor which represents the magnitude of picture motion based on the previous- and next-field picture signals, an interpolation circuit 21 adapted to generate a pixel value of a scan line to be interpolated by properly weighting and adding the previous-, current- and next-field picture signals according to the motion factor generated by the motion detection circuit 20, The de-interlacing circuit 6 still further includes a selector 22 adapted to select the previous- or next-field picture signal based on the calculation result of an adder 23 which will be described later, an adder 23 adapted to add up a motion judder calculated by the calculator 13 which is incorporated in the motion judder detection circuit 11, a mixing factor generating circuit 24 adapted to generate a mixing factor based on the addition result of the adder 23, a mixing circuit 25 adapted to generate a pixel value of a scan line to be interpolated by weighting and adding output signals of the interpolation circuit 21 and selector 22, and an interlaced-to-progressive conversion circuit 26 adapted to generate a progressive signal by interleaving the scan line interpolated by the mixing circuit 25 and the actual scan line of the current field.

The progressive signal generated by the interlaced-to-progressive conversion circuit 26 is output from the output terminal 7.

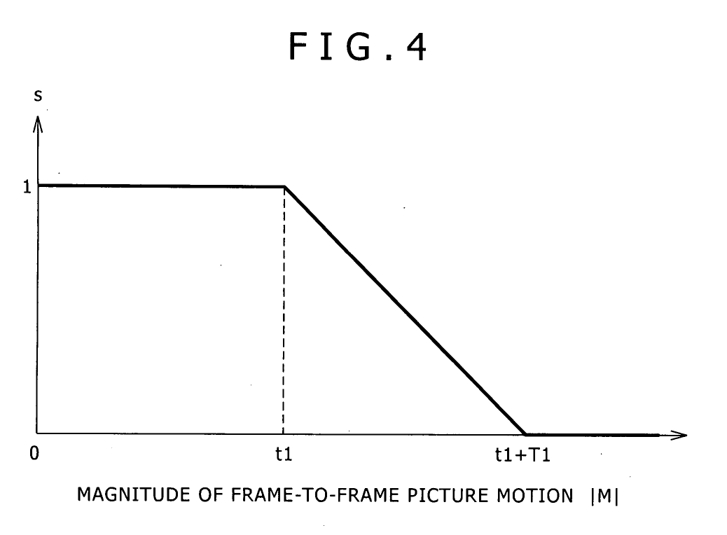

The operation of the picture signal processing device according to the first embodiment will be described below with reference to FIGS. 4 to 8.

The simplest implementation of the frame motion detection circuit 8 is to find the difference in luminance between pixels distant from each other by one frame. If a luminance signal is contained in the picture signal received from the input terminal 1, the frame motion detection circuit 8 can be configured only with a subtractor. The subtractor finds the difference between the previous- and next-field luminance signal components. The frame-to-frame motion obtained at this time is a scalar quantity. To avoid the impact of high-frequency noise or find the block-by-block average motion quantity, low-pass spatial filters may be provided, one before and the other after the subtractor. Each block is made up of a plurality of pixels.

The field motion detection circuit 9 can be configured only with a subtractor as with the frame motion detection circuit 8. For an interlaced signal, however, there is a half-line offset in the display position of the scan lines between fields. Therefore, if the field motion detection circuit 9 is configured only with a subtractor, the field motion detection circuit 9 finds the difference in luminance between pixels distant from each other by half a line on the screen. To find a more accurate field-to-field motion, it suffices to use two spatial filters. These filters have group delays different by half a line from each other. One of the filters is applied to the current-field luminance signal. The other filter is applied to the next-field luminance signal. The output signals of these spatial filters are subtracted, one from the other, with the subtractor.

In the description given below, a case is considered in which both the frame motion detection circuit 8 and field motion detection circuit 9 are configured only with a subtractor for simplicity. The output of the frame motion detection circuit 8, namely, the frame-to-frame motion, will be hereinafter written as M assuming that it is the value obtained by subtracting the next-field luminance signal component from the previous-field luminance signal component. Similarly, the output of the field motion detection circuit 9, namely, the field-to-field motion, will be hereinafter written as m assuming that it is the value obtained by subtracting the next-field luminance signal component from the current-field luminance signal component.

The still image determination circuit 10 determines the probability that there is no picture motion between frames using a function which decreases monotonically with respect to the frame-to-frame motion M. More specifically, the still image determination circuit 10 outputs a total sum S of a value s found by the following equation over the entire display screen in relation to positive constants t1 and T1. This total sum S represents the probability that there is no picture motion between frames.

s=med{0,1,(|M|−t1)/T1}

In the above equation, “med {x, y, z}” is a function adapted to select the median of x, y and z. On the other hand, “/” is a division symbol. “|x|” is a symbol representing the absolute value of x. “s” is monotonically decreasing, namely, monotonically non-increasing, with respect to M in a broad sense, as illustrated in FIG. 4.

The calculator 13 incorporated in the motion judder detection circuit 11 calculates a motion judder j from the values M and m. As described later, the motion judder detection circuit 11 calculates the motion judder j so that the absolute value of the judder j takes on a large value when the absence of motion is detected between fields despite the fact that a large motion is detected between frames. Such a motion judder is typical of telecine materials and hardly occurs in ordinary video materials.

The calculator 13 calculates the judder j using a transform function g given below. The transform function g has M and m as variables.

j=g(M,m)

where

g(M,m)=|αM×(1+2×m/M)

when −0.5≦m/M<0

g(M,m)=|αM|×(1−2×m/M)

when 0≦m/M<1

g(M,m)=−|αM|×(3−2×m/M)

when 1≦m/M<1.5

g(M,m)=0

when other than the above

In the above equations, α is a constant, and α×M is abbreviated as αM.

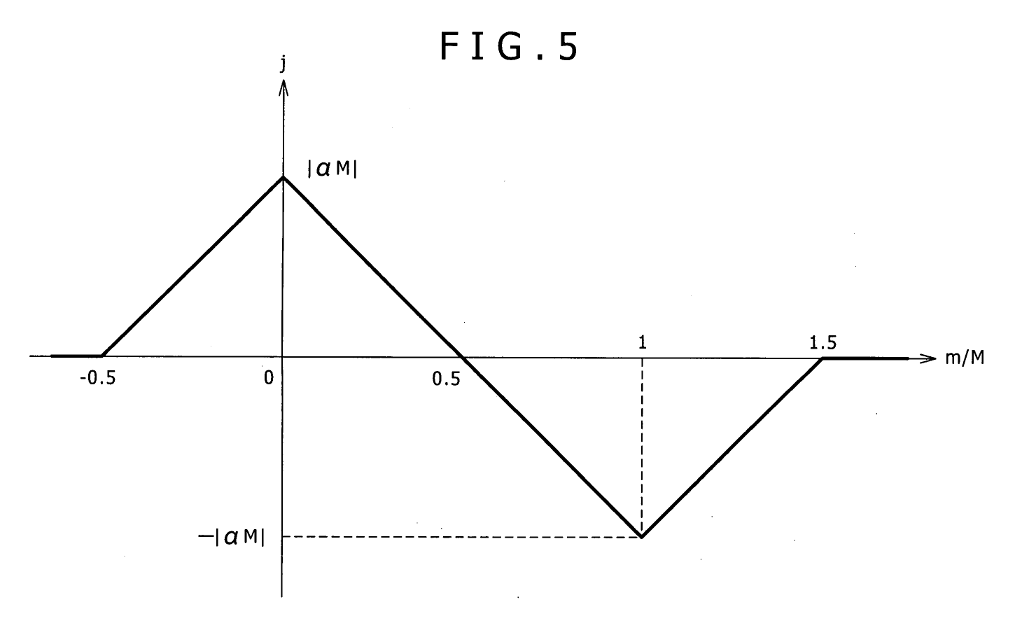

FIG. 5 illustrates the change of j with respect to m/M. As is clear from FIG. 5, the absolute value of j is maximal when m=0 and m=M. That is, the absolute value of j is maximal when the field-to-field picture motion m is 0 or equal to the frame-to-frame picture motion M. In particular, m=0 means that there is no picture motion between the current and next fields. m=M means that there is no picture motion between the current and previous fields.

When m=0 or m=M, |j|=|αM|. This value increases monotonically with respect to the absolute value of the frame-to-frame picture motion M. This means that the greater the frame-to-frame picture motion, the larger the motion judder. The value j found by the calculator 13 is output to the accumulator 14 and employed by the de-interlacing circuit 6 at the same time.

The transform function g described above is not limited to function which can find the motion judder j. For example, the motion judder j may be calculated by the transform function h shown below by taking j=h(M,m).

h(M,m)=med{−1,1,g(M,m)}

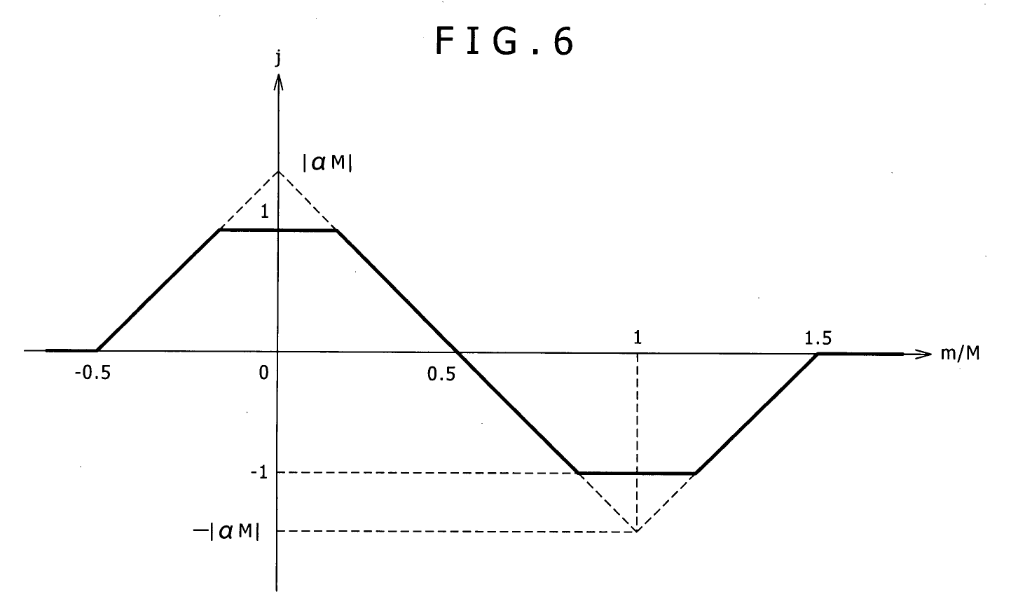

If the transform function h is used, the change of j with respect to m/M is as shown in FIG. 5 when |αM|≦1 and as shown in FIG. 6 in any other case. At this time, |j| is monotonically increasing, namely, monotonically non-decreasing, with respect to |M| in a broad sense. Even if the transform function h is used, the absolute value of the motion judder j takes on a large value also when there is a picture motion between frames and when there is no picture motion between fields.

The accumulator 14 accumulates the motion judder j, output from the calculator 13, in the spatial direction. That is, the accumulator 14 resets the accumulated sum to 0 each time a reference edge of a vertical synchronizing signal is received from the input terminal 2. Each time the new motion judder j is calculated by the calculator 13, the accumulator 14 adds j to a currently stored accumulation result J. This provides the total sum of the motion judder j over the entire display screen.

The film determination circuit 12 determines, using the accumulation result J from the accumulator 14, the probability that the picture signal input from the input terminal 1 is an interlaced signal generated by the telecine process.

The identification circuit 18 identifies the picture status using a determination result S of the still image determination circuit 10, the accumulation result J of the accumulation circuit 14 and three positive threshold values Sa, Ja and Jb. Assuming the value output by the identification circuit 18 to be p, the value p can be found as follows:

p=−2 when S<Sa and −Jb≦J<Ja

p=−1 when S<Sa and J<−Jb

p=0 when S≧Sa

p=1 when S≦Sa and J≧Ja

p=0 is associated with a still image, p=0 a moving image of a video material, and any other case a telecine material. Considering the fact that the values S and J are finalized when a reference edge of a vertical synchronizing signal is received which represents the start of a next field, the current and next fields are highly likely to be derived from the same film frame when p=1. On the other hand, when p=−1, the previous field and the one before the previous field are highly likely to be derived from the same film frame. In particular, when p=−1, the current and next fields are also highly likely to be derived from the same film frame, on the precondition that the input picture signal remains unchanged as a telecine material.

The shift register 19 includes two registers. The register value at each stage is updated each time a reference edge of a vertical synchronizing signal is received. That is, the value of the first-stage register is updated to p which is the output of the identification circuit 18. The value of the second-stage register is updated to that of the first-stage register. The series of values stored in the two registers represents the pattern associated with the status change of the input picture signal over time.

The pattern ROM 16 stores four patterns to be compared with the value of the shift register 19. Each of the patterns stored in the pattern ROM 16 is made up of an arrangement of up to two numbers to match the two registers of the shift register 19.

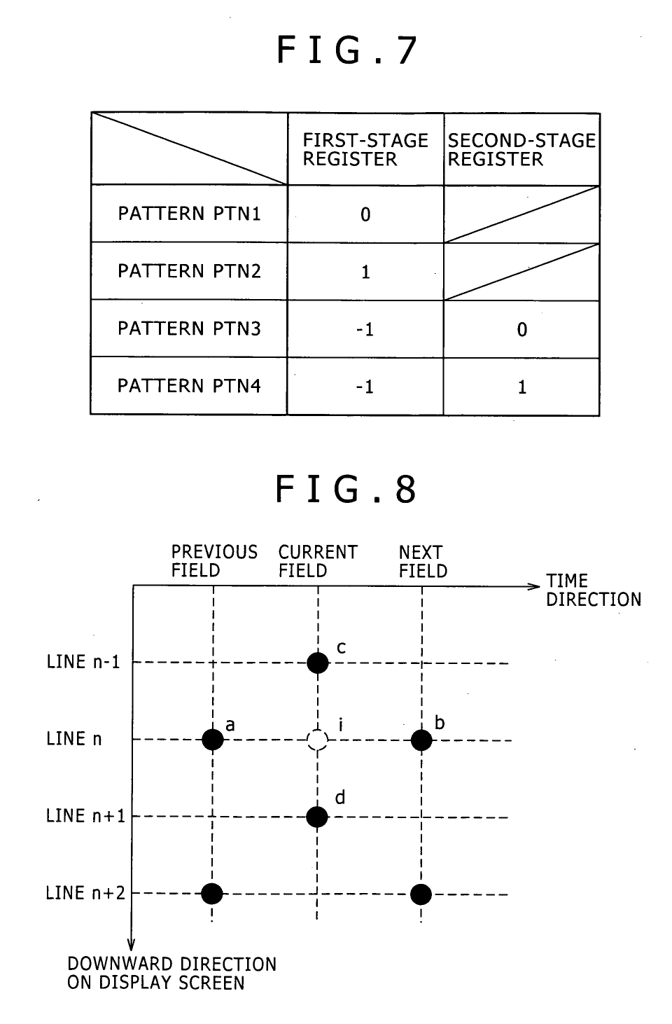

The patterns stored in the same ROM 16 are illustrated in FIG. 7. A pattern PTN1 is made up of 0, a pattern PTN2 1, a pattern PTN3 −1 and 0, and a pattern PTN4 −1 and 1.

The pattern comparison circuit 17 determines that the pattern PTN1 in FIG. 7 matches the pattern represented by the shift register 19 when the value of the first-stage register of the shift register 19 is 0.

In the same manner, the pattern comparison circuit 17 determines that the pattern PTN2 in FIG. 7 matches the pattern represented by the shift register 19 when the value of the first-stage register is 1. The pattern comparison circuit 17 determines that the pattern PTN3 in FIG. 7 matches the pattern represented by the shift register 19 when the values of the first- and second-stage registers are −1 and 0, respectively. The pattern comparison circuit 17 determines that the pattern PTN4 in FIG. 7 matches the pattern represented by the shift register 19 when the values of the first- and second-stage registers are −1 and 1, respectively.

When the pattern represented by the shift register 19 matches the pattern PTN1 or PTN2, the pattern comparison circuit 17 outputs a negative value −β considering that it is highly likely that the input picture signal is an interlaced signal generated by the telecine process and that the current and previous fields are derived from the same film frame. When the pattern represented by the shift register 19 matches the pattern PTN3 or PTN4, the pattern comparison circuit 17 outputs a positive value γ considering that it is highly likely that the input picture signal is an interlaced signal generated by the telecine process and that the current and next fields are derived from the same film frame. In any other case, the pattern comparison circuit 17 outputs 0 considering that it is unlikely that the input picture signal is an interlaced signal generated by the telecine process.

The output value of the pattern comparison circuit 17 is fed to the de-interlacing circuit 6 as the output value of the film determination circuit 12. Hereinafter, the output value of the film determination circuit 12 will be written as F. The absolute value of F represents the probability that the input picture signal is an interlaced signal generated by the telecine process. The sign of F is used to identify fields which are derived from the same film frame.

The de-interlacing circuit 6 converts the interlaced signal from the input terminal 1 into a progressive signal using F obtained from the film determination circuit 12 and j obtained from the motion judder detection circuit 11. The de-interlacing circuit 6 outputs the resultant progressive signal from the output terminal 7.

As illustrated in FIG. 8, the pixel value of the current field to be interpolated will be written as i, the pixel value one field preceding i as a, the pixel value one field succeeding i as b, the pixel value one line above i on the display screen as c, and the pixel value one line below i on the display screen as d. The values c and d are obtained from the first field memory 3. The value a is obtained from the second field memory 4. The value b is contained in the picture signal received from the input terminal 1.

The motion detection circuit 20 generates a motion factor k1 from the previous- and next-field picture signals. In the description given below, the value obtained by transforming the absolute value of the difference between the luminance signal components of a and b with a non-linear monotonically non-decreasing function is assumed to be the motion factor k1. That is, the larger the absolute value of the difference between the luminance signal components of a and b, the larger the motion factor k1. In particular, when the luminance signal components of a and b match, k1=0.

The interpolation circuit 21 generates an interpolation value suitable for a video material of the input picture signal from the values a, b, c, d and k1. Here, v obtained by the following equation is assumed to be the output value of the interpolation circuit 21.

v=(1−k1)×(a+b)/2+k1×(c+d)/2

The larger the motion factor k1, the more apt the interpolation circuit 21 is to select “(c+d)/2” which is the average of the upper and lower lines. Conversely, the smaller the motion factor k1, the more apt the interpolation circuit 21 is to select “(a+b)/2” which is the frame-to-frame average.

The selector 22 generates an interpolation value suitable for a telecine material from the values a and b and an output value F+j of the adder 23. Here, f obtained by the following equation is assumed to be the output value of the selector 22.

f=a when F+j<0

f=b when F+j≧0

If it is highly likely that the current and previous fields are derived from the same film frame, the selector 22 is apt to select the pixel value a of the previous field. In any other case, the selector 22 is apt to select the pixel value b of the next field.

The mixing factor generating circuit 24 generates a mixing factor k2 from the value F+j. That is, the mixing factor generating circuit 24 outputs k2, obtained by the following equation, to the mixing circuit 25 as a mixing factor for two positive constants t2 and T2.

k2=med{0,1,(|F+j|−t2)/T2}

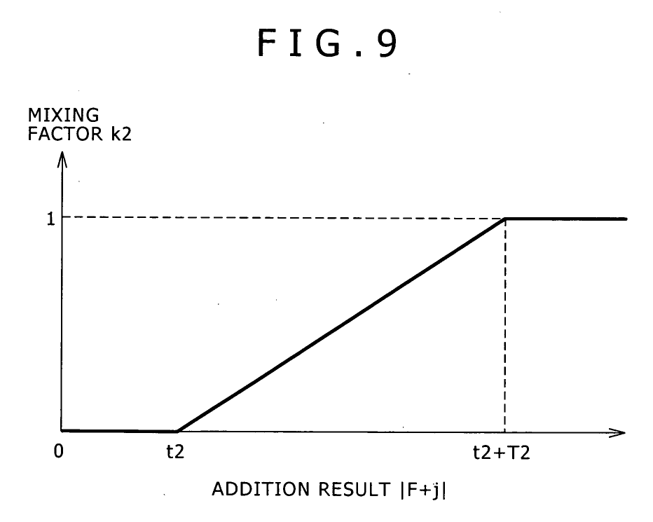

FIG. 9 illustrates the relationship between the mixing factor k2 and the output value F+j of the adder 23. k2 represents the probability that the input picture signal is a telecine material.

The mixing circuit 25 generates a final interpolation value i with the following function using the output value v of the interpolation circuit 21, the output value f of the selector 22, and the mixing factor k2 generated by the mixing factor generating circuit 24.

i=(1−k2)×v+k2×f

The larger k2, the more apt the interpolation method suitable for a telecine material is to be selected. The smaller k2, the more apt the interpolation method suitable for a video material is to be selected. Thus, the picture signal processing device 100 performs de-interlacing in different manners, one tailored to a telecine material and the other to a video material.

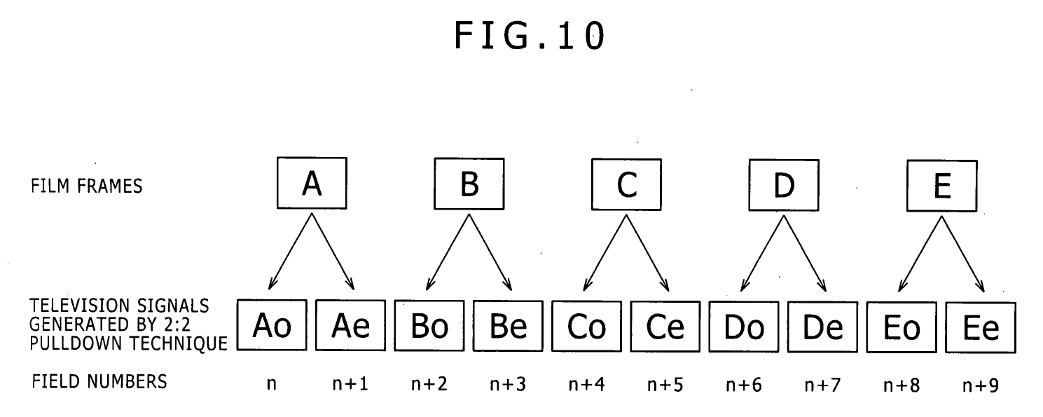

A description will be given below of the reason why the picture signal processing device 100 configured as described above can detect a telecine material having an arbitrary pulldown sequence using a common circuit. A description will also be given of the reason why the picture signal processing device 100 is resistant to erroneous de-interlacing even in the presence of an edit point or hybrid material while offering quick detection response without sacrificing film detection accuracy. FIGS. 10 to 15 will be referred to for the description.

FIG. 10 is a view illustrating the telecine process using the 2:2 pulldown technique.

Picture frames recorded on film are termed A, B, C and D in order of transmission, from earliest to latest. These are progressive signals. The telecine process using the 2:2 pulldown technique divides each film frame into two fields, one made up of odd lines and the other even lines, thus generating an interlaced signal. Two fields derived from the frame A will be written as Ao and Ae. Although captured at the same time, Ao and Ae are transmitted with a time lag of one field between them when used as a television signal for broadcasting. Here, the field transmitted next to Ao will be written as Ae. In the same manner, two fields derived from each of B, C and D will be written as Bo, Be, Co, Ce, Do and De, in order of transmission from earliest to latest. Further, the times when Ae to De are fed to the input terminal 1 are termed fields n+1 to n+9, respectively.

Here, a case will be considered in which the film frames are different in image content from one another. At this time, the frame motion detection circuit 8 constantly detects a frame-to-frame picture motion. Therefore, the determination result S of the still image determination circuit 10 is highly likely to be smaller than Sa. As a result, the identification result p of the identification circuit 18 is unlikely to be 0.

Further, if the current and previous fields are derived from the same film frame, the calculation result j of the calculator 13 incorporated in the motion judder detection circuit 11 is highly likely to be negative. As a result, the accumulation result J, which is the result of accumulating j, is highly likely to be less than −Jb.

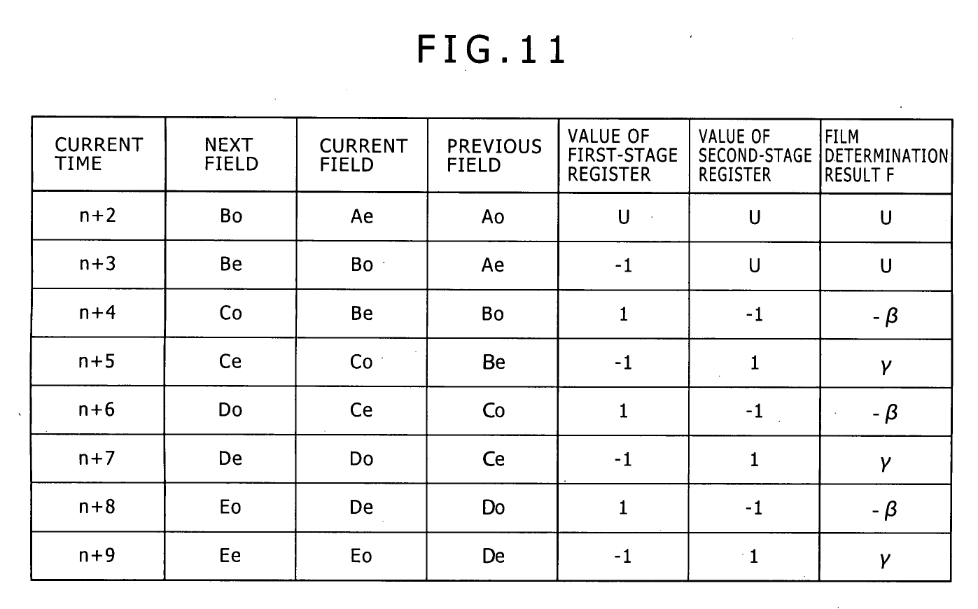

When S<Sa and J<−Jb, the identification result p of the identification circuit 18 is −1 as mentioned earlier. In the same manner, when the current and next fields are derived from the same film frame, the identification result p is highly likely to be 1. This is shown in a diagram in FIG. 11.

FIG. 11 shows the image contents of the next, current and previous fields, the values of the two registers incorporated in the shift register 19 and the determination result F of the film determination circuit 12 at different times. In FIG. 11, U in the register value and determination result columns denotes that the value is unknown.

As an example, the field n+2 will be considered in which the previous, current and next fields are Ao, Ae and Bo.

The values S and J for the field n+2 are finalized when a reference edge of a vertical synchronizing signal is received which represents the end of the field n+2. At the time of the field n+2, therefore, the value of the first-stage register of the shift register 19 is U. The identification result p=−1 of the identification circuit 18 for the field n+2 is reflected for the first time in the field n+3. The same is true for the field n+3 onward.

The pattern generated by the pattern generating circuit 15 using the shift register 19 matches the pattern PTN2 or PTN4 in FIG. 7. Therefore, when the input picture signal is generated by the 2:2 pulldown technique, the determination result F of the film determination circuit 12 is always non-0. As a result, it is determined that the input picture signal is probably a television signal generated by the telecine process.

Further, as a result of the operation of the pattern comparison circuit 17, F=−β in the fields n+4, n+6 and n+8. Still further, the current and previous fields are derived from the same film frame in these fields. Therefore, M and m are roughly equal to each other. j is negative. Therefore, we can say that it is highly likely that F+j<0 and |F+j|>t2+T2 in the fields n+4, n+6 and n+8.

If the conditions F+j<0 and |F+j|>t2+T2 are satisfied, the output value f of the selector 22 is a. In this case, the mixing factor k2 generated by the mixing factor generating circuit 24 is close to 1. As a result, a is apt to be selected by the mixing circuit 25 as the interpolation value i.

In the fields n+4, n+6 and n+8, the current and previous fields are derived from the same film frame. Therefore, the operations described above allow the de-interlacing circuit 6 to properly restore the original film frame.

The same is true for the fields n+5, n+7 and n+9 in which F=γ. That is, when the current and next fields are derived from the same film frame, the two conditions F+j<0 and |F+j|>t2+T2 are highly likely to be satisfied. b is apt to be selected as the interpolation value. As a result, the original film frame can be properly restored.

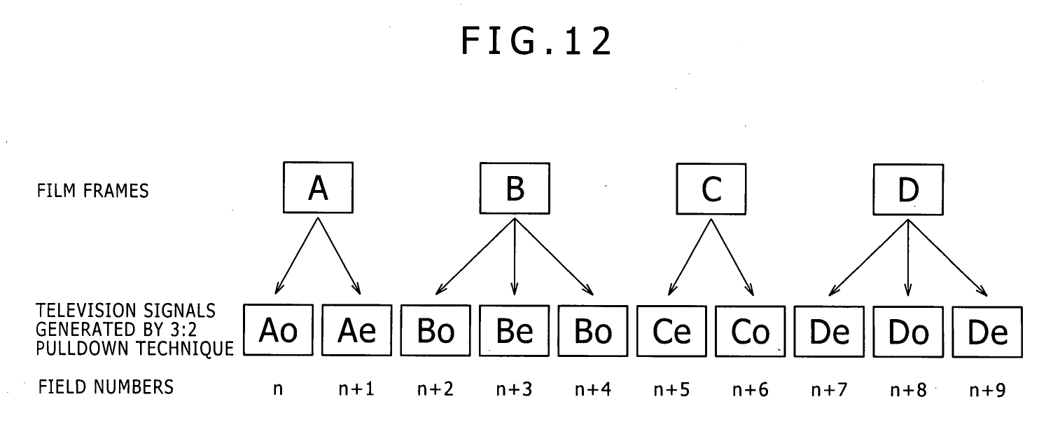

Next, a case will be considered in which the input picture signal is generated by the telecine process using the 3:2 pulldown technique. The 3:2 pulldown technique divides a single film frame sometimes into two and other times into three as illustrated in FIG. 12. When a single film frame is divided into three fields, the first and third fields are completely identical.

In FIG. 12, the fields (Bo) input to the fields n+2 and n+4 are identical, and the fields (De) input to the fields n+7 and n+9 are also identical.

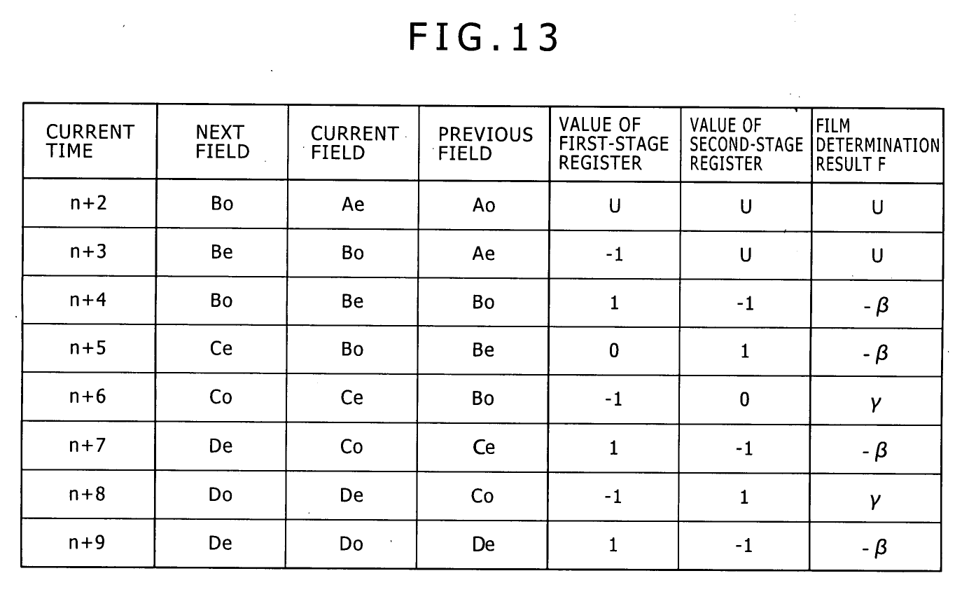

If the film frames are different in image content from one another, the detection results of the film determination circuit 12 regarding a telecine material resulting from the 3:2 pulldown technique are as shown in FIG. 13.

In the field n+4, the next and previous fields are both Bo. Therefore, M detected by the frame motion detection circuit 8 is 0. As a result, the determination result S of the still image determination circuit 10 is highly likely to be greater than Sa. As described earlier, when S≧Sa, p=0. Therefore, the value of the first-stage register of the shift register 19 is 0 in the field n+5.

In the field n+5, the pattern generated by the pattern generating circuit 15 matches the pattern PTN1 in FIG. 7. In the field n+6, on the other hand, the pattern generated by the same circuit 15 matches the pattern PTN3 in FIG. 7. In the fields n+4, n+7 and n+9, the pattern generated by the same circuit 15 matches the pattern PTN2. In the field n+8, the pattern generated by the same circuit 15 matches the pattern PTN4.

As described above, the pattern generated by the pattern generating circuit 15 matches one or more of the patterns in FIG. 7 for any field. Therefore, the film detection circuit 5 can also handle film detection properly even in the case of the 3:2 pulldown technique.

The de-interlacing circuit 6 operates in the fields n+7 and n+8 in the same manner as described in the example using the 2:2 pulldown technique. Therefore, a description will be given below of the operation of the de-interlacing circuit 6 for a period from the field n+4 to the field n+6. It should be noted that the de-interlacing circuit 6 operates in the field n+9 exactly in the same manner as in the field n+4.

First, the operation of the de-interlacing circuit 6 in the field n+4 will be described.

In the field n+4, the next and previous fields are completely identical. As a result, M=0 and j=0. On the other hand, the value F is −β which is negative. As a result, it is highly likely that F+j<0.

Therefore, the output value f of the selector 22 is highly likely to be a. On the other hand, the motion factor k1, which is the output value of the motion detection circuit 20, is 0 as described earlier when the next and previous fields match in image content. As a result, the output value v of the interpolation circuit 21 is the average of a and b. In the field n+4, a=b. As a result, the average of a and b is equal to a.

The input value of the mixing circuit 25 is f=v=a. As a result, the interpolation value i is equal to a irrespective of the mixing factor k2. This is correct in terms of the operation of the de-interlacing circuit 6.

Next, the operation of the de-interlacing circuit 6 in the field n+5 will be considered. In this field, the pattern generated by the pattern generating circuit 15 matches the pattern PTN1.

In the field n+5, the current and previous fields are derived from the same film frame. As a result, the value j is highly likely to be negative as the value F. Therefore, it is highly likely that F+j<0 and |F+j|>t2+T2. As a consequence, a which is the pixel value of the previous field is highly likely to be selected as the interpolation value i.

In the field n+6, the pattern generated by the pattern generating circuit 15 matches the pattern PTN3. In this field, the current and next fields are derived from the same film frame. As a result, the value j is highly likely to be positive as the value F. Therefore, it is highly likely that F+j>0 and |F+j|>t2+T2. As a consequence, b which is the pixel value of the next field is highly likely to be selected as the interpolation value i.

As described above, the de-interlacing circuit 6 can properly restore the original film frame even in the case of the 3:2 pulldown technique.

The film detection circuit 5 and de-interlacing circuit 6 according to the first embodiment can handle film detection and de-interlacing properly even for an interlaced signal generated by the telecine process using a pulldown technique other than the 2:2 and 3:2 pulldown techniques.

The pulldown process always divides a single film frame into two or more fields. If a film frame is divided into three or more fields, the third field and beyond always match the field two fields previous to them. In the third field and beyond, therefore, the detection result M of the frame motion detection circuit 8 is always 0 (M=0). The determination result S of the still image determination circuit 10 is greater or equal to Sa (S≧Sa). As a result, the pattern generated by the pattern generating circuit 15 matches the pattern PTN1.

The pattern generated by the pattern generating circuit 15 does not match the pattern PTN1 if only the next field is derived from a different film frame. In this case, the pattern generated by the pattern generating circuit 15 matches the pattern PTN3 as a result of the operation which is exactly the same as in the field n+6 in FIG. 13.

Further, the next and current fields are derived from the same film frame one field later. As a result, the pattern generated by the pattern generating circuit 15 matches the pattern PTN4.

In the succeeding fields, the pattern generated by the pattern generating circuit 15 matches the pattern PTN1 until a field appears which is derived from a different film frame as described above. Therefore, the film detection circuit 5 can detect an arbitrary pulldown sequence other than the 2:2 or 3:2 pulldown sequence.

The de-interlacing circuit 6 can restore the original film frame properly when the pattern generated by the pattern generating circuit 15 matches one of the patterns stored in the pattern ROM 16. This has been already explained using examples of 2:2 and 3:2 pulldown. Therefore, the de-interlacing circuit 6 can also detect an arbitrary pulldown sequence other than 2:2 and 3:2 pulldown sequences.

Next, highly accurate film detection of the film detection circuit 5 according to the first embodiment will be described.

A telecine material is characterized in that it is generated by division of a single film frame into a plurality of fields. For this reason, there is no picture motion between fields in all areas where there is a picture motion between frames. This hardly occurs in ordinary video materials.

The motion judder detection circuit 11 detects the case where there is a picture motion between frames but no picture motion between fields. This allows the motion judder detection circuit 11 to suppress erroneous film detection. In particular, a picture motion between frames can be detected by using even or odd fields. Therefore, erroneous detection is unlikely even if the original film frame contains a vertical high frequency component. Simple detection of a field-to-field picture motion independently of the frame-to-frame picture motion may result in erroneous detection in a still image area containing a vertical high frequency component.

However, detection of a field-to-field picture motion only in an area having a frame-to-frame picture motion can suppress erroneous detection caused by a vertical high frequency component. This is advantageous if a telecine material contains many vertical high frequency components and if the frame-to-frame picture motion is small.

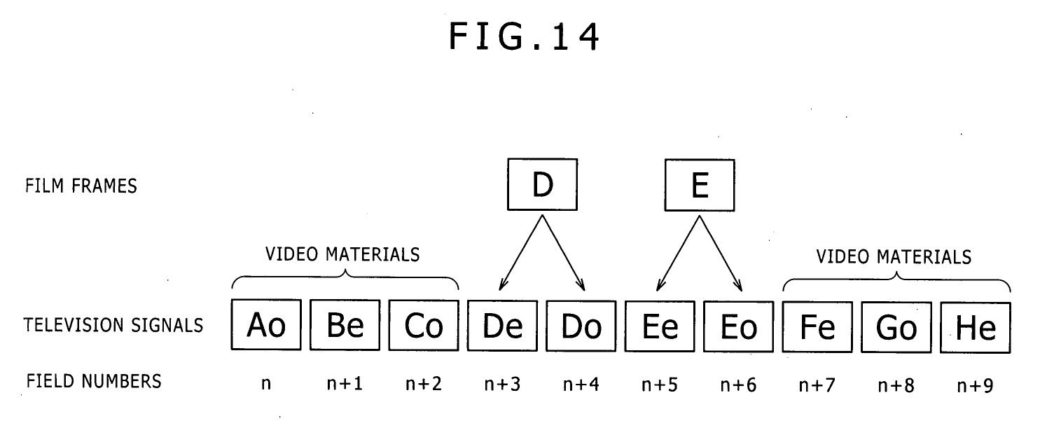

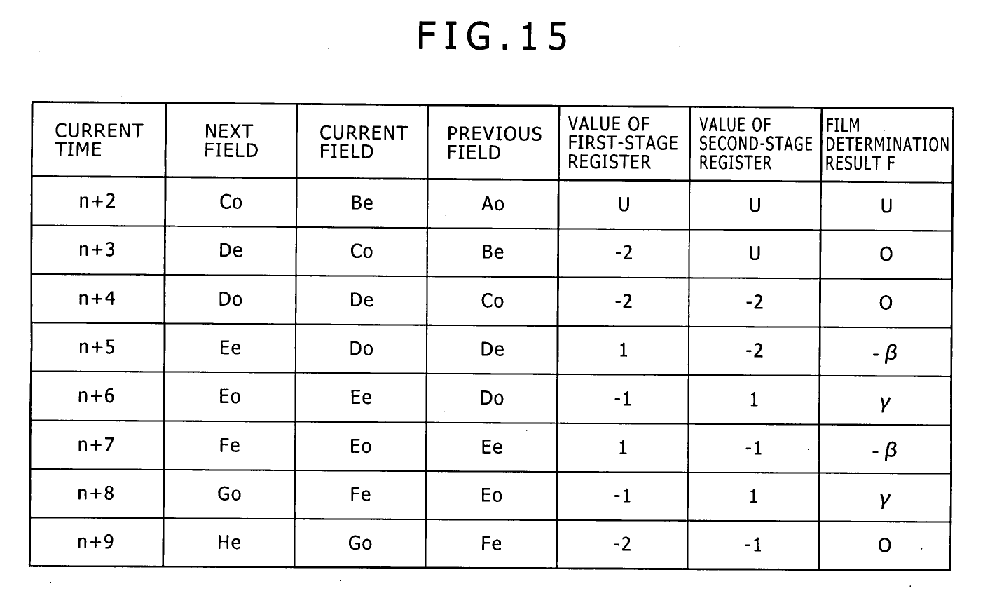

The film detection circuit 5 and de-interlacing circuit 6 according to the first embodiment can quickly handle frequent switching between telecine and video materials. This will be described next with reference to FIGS. 14 and 15.

FIG. 14 is a view illustrating switching between video and telecine materials. We assume that, of the nine fields from Ao to He in FIG. 14, the four fields De, Do, Ee and Eo are telecine materials generated using the 2:2 pulldown technique and that the other five fields are video materials. Further, we assume that the film frames are different in image content from one another and that the video material fields are different in image content from one another.

The detection results of the film detection circuit 5 are as shown in FIG. 15 when the input is as shown in FIG. 14.

That is, the next, current and previous fields are different in image content from one another in the field n+2. For this reason, there is a picture motion between frames and between fields. Therefore, the value s detected by the still image determination circuit 10 is close to 0. As a result, the accumulated sum S obtained by accumulating s is highly likely to be smaller than Sa.

Further, m/M is in the neighborhood of 0.5. Therefore, the motion judder j detected by the motion judder detection circuit 11 is close to 0. As a result, the accumulated sum J obtained by accumulating j is highly likely to be −Jb≦J<Ja.

When S<Sa and −Jb≦J<Ja, p=−2 as described earlier. Therefore, the value of the first-stage register of the shift register 19 is −2 in the field n+3. This does not match any of the patterns in FIG. 7. As a result, the determination result F of the film determination circuit 12 is 0.

In the succeeding fields, the determination result F of the film determination circuit 12 is not 0 for a period from the field n+5 to the field n+8. The current field is a telecine material from the field n+4 to the field n+7. This means that the film determination circuit 12 makes a correct determination in one field after the switching of the input picture signal.

In the field n+4, F=0 despite the fact that the current and next fields are derived from the same film frame. In this field, however, j is highly likely to be positive. Therefore, F+j is also highly likely to be more or less a large positive value. As a result, the value close to b is highly likely to be selected as the interpolation value i. Consequently, the de-interlacing circuit 6 is highly likely to be able to restore the original film frame in the field n+4 as well.

In the field n+8, on the other hand, F is a non-O value despite the fact that all the fields are video materials. In this field, j is close to 0. Therefore, as long as γ is set to be more or less small with respect to t2, |F+j| will not exceed t2. As a result, k2=0. Consequently, the output value v of the interpolation circuit 21, which is suitable for a video material, is highly likely to be selected as the interpolation value i.

As described above, the film detection circuit 5 can achieve film detection in an extremely short period of time, and the de-interlacing circuit 6 can select an appropriate interpolation value quickly in response to the status of the input picture signal.

In a practical television signal, telecine and video materials may be frequently switched, for example, as a result of editing of telecine materials. However, the film detection circuit 5 and de-interlacing circuit 6 according to the first embodiment can detect telecine materials with many picture edit points as well.

The de-interlacing circuit 6 according to the first embodiment can detect a hybrid material containing telecine and video materials in the same field image. This will be described lastly.

A hybrid material often contains a video material in a relatively small area of the display screen. At this time, the detection result F of the film detection result 5 is highly likely to be non-0 because of a telecine material which occupies the majority of the screen.

In the image area made up of a video material, on the other hand, as long as there is a picture motion between frames, there is a picture motion both between the current and next fields and between the current and previous fields.

As a consequence, the value j detected in the moving image area made up of a video material is close to 0. As long as β and γ are set to be more or less small with respect to t2, |F+j| will not exceed t2. As a result, k2=0. Consequently, v which is suitable for a video material will be selected as the interpolation value i.

In the image area made up of a telecine material, on the other hand, the signs of F and j are highly likely to be the same. Therefore, |F+j| will exceed t2. Consequently, f which is suitable for a telecine material will be selected as the interpolation value i.

In the still image area, there is no picture motion between frames. Therefore, j is close to 0 irrespective of whether this area is made up of a telecine or video material. As a result, F+j is determined almost uniquely by F. It should be noted, however, that either f or v may be selected as the interpolation value i for the still image area. In this case, therefore, the value F+j may be arbitrary.

Therefore, the de-interlacing circuit 6 according to the first embodiment can handle de-interlacing properly even in the case of a hybrid material.

As described above, the picture signal processing device according to the first embodiment can detect a telecine material having an arbitrary pulldown sequence with a common circuit. The same device is resistant to erroneous de-interlacing even in the presence of an edit point or hybrid material while offering quick detection response without sacrificing film detection accuracy.

In the first embodiment, a case has been description in which the frame-to-frame and field-to-field picture motions are detected as scalar quantities. However, these motions may be detected as vector values. The gradient method is known as a detection method adapted to detect a picture motion on a pixel-by-pixel basis. The block matching method is known as a detection method adapted to detect a picture motion on a block-by-block basis.

To detect the motion judder j using the frame-to-frame and field-to-field picture motions which are vector values, the transform function g or h need only be calculated by assuming the norm of the frame-to-frame motion vector to be M and that of the field-to-field motion vector to be m.

In addition to the above, a transform function may be defined so that the motion judder j is dependent upon the direction of the motion vector. Also in this case, the same effects can be achieved as those of the first embodiment if the absolute value of the transform function is maximal when the field-to-field motion vector is 0 or equal to the frame-to-frame motion vector and if the absolute value of the transform function at this time is monotonically non-decreasing with respect to the norm of the frame-to-frame motion vector.

Further, the first embodiment performs de-interlacing based on the motion judder j and the addition result of the film determination result F. However, de-interlacing may be performed using only the motion judder j. In this case, the operation is the same as when the film determination result F is always 0. If the de-interlacing methods are changed only in response to the motion judder j, the detection accuracy drops slightly for images locally containing many vertical high frequency components. Nevertheless, the same effects can be obtained as those of the first embodiment.

Further, the shift register 19 of the first embodiment has two stages. However, the present invention is not limited thereto, and the shift register 19 may have more than two stages.

For example, the shift register 19 may have five stages so that the pattern ROM 16 stores a pattern made up of five numbers, namely, 0, 1, −1, 1 and −1. The value of the first register is 0, the values of the second and fourth registers are 1, and those of the third and fifth registers −1 when the input picture signal is a television signal generated by the 3:2 pulldown technique. As a result, the above pattern allows for detection of a 3:2 pulldown sequence.

Further, the adder 23 is incorporated in the de-interlacing circuit 6 in the first embodiment. However, the adder 23 may be incorporated in the film detection circuit 5. In this case, F+j is the film detection result.

### Second Embodiment

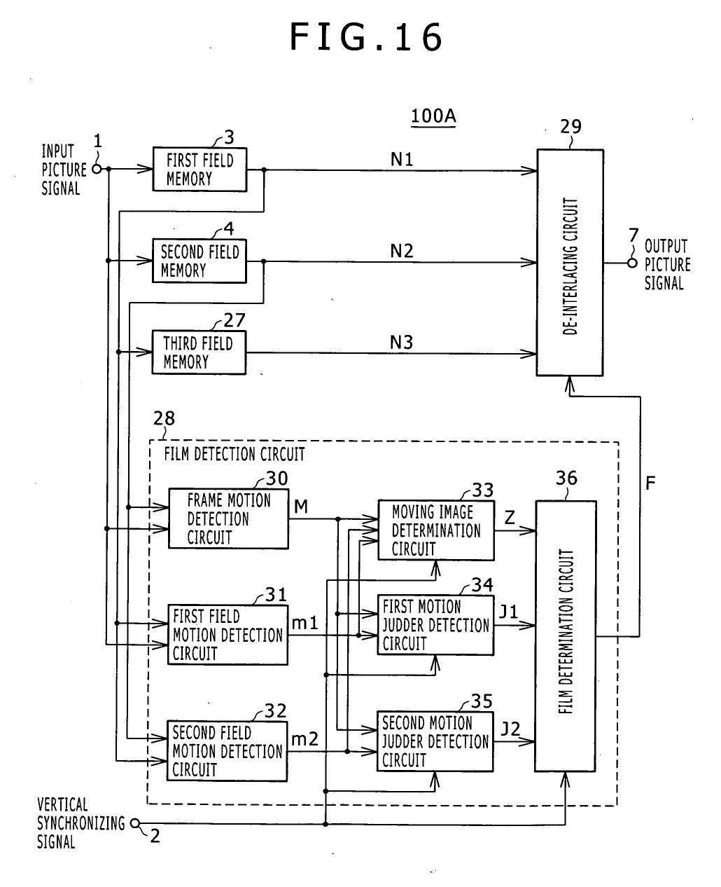

FIG. 16 is a view illustrating the overall configuration of the picture signal processing device according to a second embodiment of the present invention.

In FIG. 16, the components having the same function as those in the first embodiment are denoted by the same reference numerals, and a description thereof will be omitted.

A picture signal processing device 100A according to the second embodiment includes, a third field memory 27 adapted to delay a picture signal, which has been delayed by two fields, by one more field so as to delay the picture signal received from the input terminal 1 by three fields, a film detection circuit 28 adapted to determine whether the picture signal received from the input terminal 1 is an interlaced signal generated by the telecine process, and a de-interlacing circuit 29 adapted to change de-interlacing methods according to the detection result of the film detection circuit 28.

The de-interlacing circuit 29 according to the second embodiment differs from the de-interlacing circuit 6 according to the first embodiment in that the circuit 29 uses the picture signals delayed by one or more fields from the picture signal received from the input terminal 1. The picture signal converted into a progressive signal by the de-interlacing circuit 29 is output from the output terminal 7.

Hereinafter, as in the first embodiment, the picture signal received from the input terminal 1 will be referred to as the “next-field picture signal”, the output picture signal of the first field memory 3 the “current-field picture signal”, and the output picture signal of the second field memory 4 the “previous-field picture signal.” Further, as necessary, the output signal of the third field memory 27 will be referred to as a “field N3 picture signal”, and the previous-, current- and next-field picture signals field N2, N1 and N0 picture signals, respectively.

The dotted line in FIG. 16 represents the film detection circuit 28. The area enclosed by the dotted line illustrates the internal configuration of the film detection circuit 28.

As illustrated in FIG. 16, the film detection circuit 28 includes, a frame motion detection circuit 30 adapted to detect a frame-to-frame picture motion using the next- and previous-field picture signals, a first field motion detection circuit 31 adapted to detect a field-to-field picture motion using the current- and next-field picture signals, a second field motion detection circuit 32 adapted to detect a field-to-field picture motion using the current- and previous-field picture signals, a moving image determination circuit 33 adapted to determine the probability that there is a given picture motion between fields for two consecutive fields using the detection results of the frame detection circuit 30, first field motion detection circuit 31 and second field motion detection circuit 32, a first motion judder detection circuit 34 adapted to detect a motion judder using the detection results of the frame detection circuit 30 and first field motion detection circuit 31, a second motion judder detection circuit 35 adapted to detect a motion judder using the detection results of the frame detection circuit 30 and second field motion detection circuit 32, and a film determination circuit 36 adapted to determine the probability that the input picture signal received from the input terminal 1 is an interlaced signal generated by the telecine process using the determination result of the moving image determination circuit 33 and the detection results of the first and second motion judder detection circuits 34 and 35.

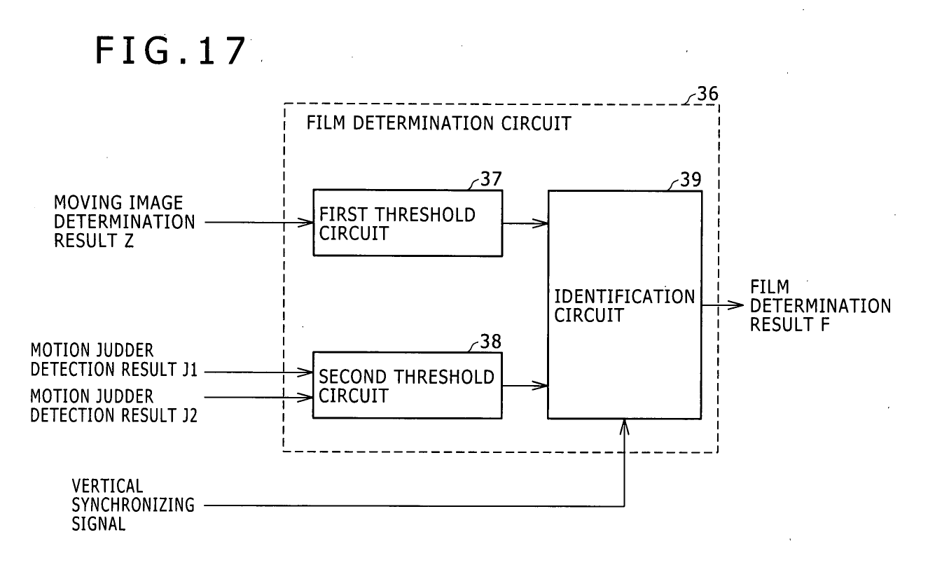

FIG. 17 is a view illustrating the internal configuration of the film determination circuit 36 according to the second embodiment.

As illustrated in FIG. 17, the film determination circuit 36 includes, a first threshold circuit 37 adapted to threshold the determination result of the moving image determination circuit 33, a second threshold circuit 38 adapted to threshold the ratio of the detection results of the first and second motion judder detection circuit 34 and 35, and an identification circuit 39 adapted to identify the status of the input picture signal based on the output values of the first and second threshold circuits 37 and 38.

The identification result of the identification circuit 39 is output to the de-interlacing circuit 29 as the determination result F of the film determination circuit 36.

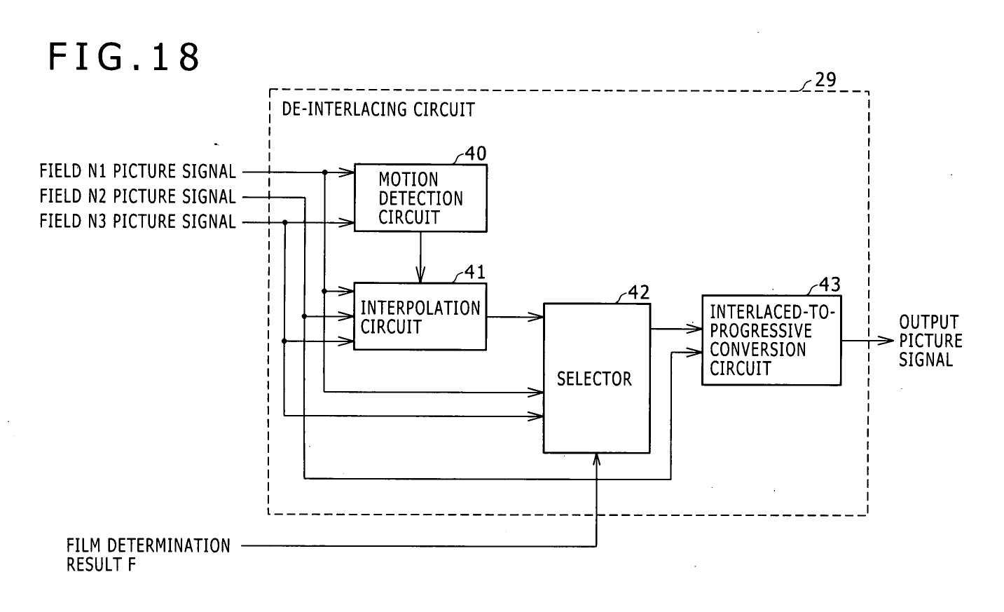

FIG. 18 is a view illustrating the internal configuration of the de-interlacing circuit 29 according to the second embodiment.

As illustrated in FIG. 18, the de-interlacing circuit 29 includes, a motion detection circuit 40 adapted to generate the motion factor k1 which represents the magnitude of the picture motion using the field N1 and N3 picture signals, an interpolation circuit 41 adapted to generate a pixel value of a scan line to be interpolated by properly weighting and adding the field N1, N2 and N3 picture signals according to the motion factor k1 generated by the motion detection circuit 40, a selector 42 adapted to select one of the three options, namely, the output signal v of the interpolation circuit 41 and field N1 and N2 picture signals, according to the determination result F of the film detection circuit 28, and an interlaced-to-progressive conversion circuit 43 adapted to generate a progressive signal by interleaving the picture signal of the scan line to be interpolated which has been selected by the selector 42 and the actual scan line of the current field.

The progressive signal generated by the interlaced-to-progressive conversion circuit 43 is output from the output terminal 7.

Here, the operation of the picture signal processing device according to the second embodiment will be described.

The frame detection circuit 30 detects, as the frame-to-frame picture motion M, the value obtained by monotonic nonlinear transform of an absolute value D0 of the difference in luminance between pixels distant only by one frame from each other.

Similarly, the first field motion detection circuit 31 finds an absolute value D1 of the difference in luminance between two pixels of the current and next fields which are spatially located at almost the same position. The same circuit 31 detects, as the field-to-field motion m1, the value obtained by monotonic nonlinear transform of the absolute value D1.

Further, the second field motion detection circuit 32 finds an absolute value D2 of the difference in luminance between two pixels of the current and previous fields which are spatially located at almost the same position. The same circuit 32 detects, as the field-to-field motion m2, the value obtained by monotonic nonlinear transform of the absolute value D2.

Low-pass spatial filters may be provided, one before and the other after where the difference in luminance is found between pixels distant by one frame or field from each other, as in the first embodiment.

In the description given below, we assume that the relationships between D0 and M, between D1 and m1 and between D2 and m2 are defined respectively by the following equations:

M=med{0,1,(D0−t3)/T3}

m1=med{0,1,(D1−t3)/T3}

m2=med{0,1,(D2−t3)/T3}

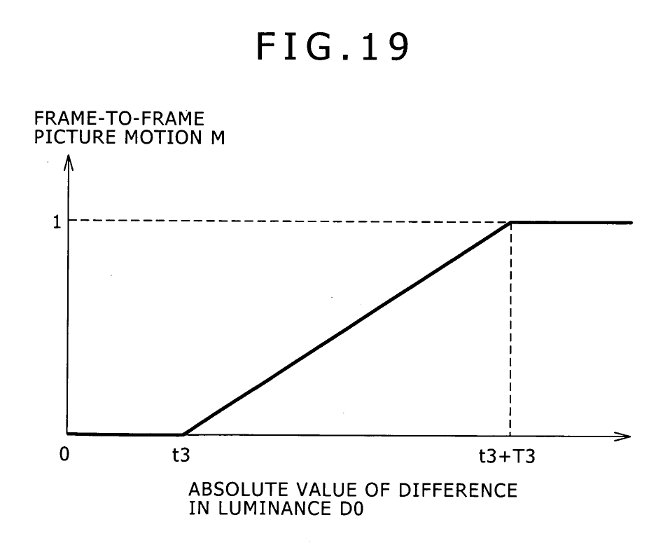

FIG. 19 is a view illustrating the relationship between the absolute value D0 and the frame-to-frame picture motion M. The relationships between D1 and m1 and between D2 and m2 are also similar to the relationship between D0 and M shown in FIG. 19.

The moving image determination circuit 33 determines the probability that there is a given picture motion between fields for two consecutive fields using the values M, m1 and m2. When the probability detected on a pixel-by-pixel basis is written as z, the total sum Z of z over the entire display screen is assumed to be the determination result of the moving image determination circuit 33.

Z=M×m1×m2

The larger the frame-to-frame and field-to-field picture motions, the larger Z. The first motion judder detection circuit 34 detects a pixel-by-pixel motion judder j1 by the equation shown below.

j1=M×(1−m1)

The motion judder j1 is maximal when m1=0, that is, when there is no picture motion between fields. The maximal value thereof increases monotonically with respect to M.

The motion judder j1 takes on a large value in a pixel where there is a picture motion between frames but no picture motion between the current and next fields. As with the motion judder detection circuit 11 according to the first embodiment, the first motion judder detection circuit 34 incorporates a calculator adapted to calculate the motion judder j1 and an accumulator adapted to find the total sum of the motion judder j1 over the entire display screen. The same circuit 34 outputs the accumulation result J1 of the accumulator to the film determination circuit 36 as the motion judder detection result. The accumulator adapted to find J1 resets the sum to 0 each time a reference edge of a vertical synchronizing signal is received from the input terminal 2.

The second motion judder detection circuit 35 detects a pixel-by-pixel motion judder j2 by the equation shown below and outputs the total sum J2 of j2 over the entire screen to the film determination circuit 36 as the detection result.

j2=M×(1−m2)

The motion judder j2 takes on a large value in a pixel where there is a picture motion between frames but no picture motion between the current and previous fields. The accumulator adapted to find J2 resets the sum to 0 each time a reference edge of a vertical synchronizing signal is received from the input terminal 2.

The first threshold circuit 37 outputs 0 when the value Z which represents the determination result of the moving image determination circuit is equal to or greater than a positive constant Za. The same circuit 37 outputs 1 in any other case. When Z≧Za, there are supposed to be quite a few pixels where z>0.

In order for z>0 to hold, the conditions M>0, m1>0 and m2>0 need be satisfied. In a pixel where z>0, therefore, there are picture motions both between frames and between fields.

That is, when the output value of the first threshold circuit 37 is 0, a part or the whole of the image area is highly likely to contain a moving image of a video material.

On the other hand, the second threshold circuit 38 compares the ratio of J1 and J2 and a positive constant λ (>1). The second threshold circuit 38 outputs 1 when J1≧λ×J2 holds. The second threshold circuit 38 outputs −1 when J2≧λ×J1 holds. The second threshold circuit 38 outputs 0 in any other case.

In a moving image of a telecine material, if the current and next fields are derived from the same film frame, and if the previous and next fields do not match in image content, m1=0 holds for many pixels. Therefore, J1≧λ×J2 is likely to hold.

Conversely, if the current and previous fields are derived from the same film frame, and if the previous and next fields do not match in image content, m2=0 holds for many pixels. Therefore, J2≧≧λ×J1 is likely to hold.

If neither J1≧λ×J2 nor J2≧λ×J1 holds, the input picture signal is probably either a still image of a telecine material or a video material.

The identification circuit 39 calculates the product of the output values of the first and second threshold circuits 37 and 38 when a reference edge of a vertical synchronizing signal is received. Identification circuit 39 outputs the obtained product as the film determination result F.

In the second embodiment, therefore, F takes on one of the values −1, 0 and 1. F=−1 when the output values of the first and second threshold circuits 37 and 38 are 1 and −1, respectively. As a result, it is highly likely that the input picture signal is a moving image of a telecine material and that the fields N2 and N3 are derived from the same film frame.

Further, F=0 when the output value of the first or second threshold circuit 37 or 38 is 0. As a result, it is highly likely that the input picture signal is a video or hybrid material or a still image of a telecine material.

Still further, F=1 when the output values of the first and second threshold circuits 37 and 38 are 1. As a result, it is highly likely that the input picture signal is a moving image of a telecine material and that the fields N1 and N2 are derived from the same film frame.

The de-interlacing circuit 29 changes methods to convert the input picture signal into a progressive signal according to the value F.

The motion detection circuit 40 and interpolation circuit 41 operate exactly in the same manner as the motion detection circuit 20 and interpolation circuit 21 according to the first embodiment. The same circuits 40 and 41 differ from their counterparts in that they use the field N1, N2 and N3 picture signals rather than the previous-, current- and next-field picture signals.

The selector 42 selects the output value of the interpolation circuit 41 as the interpolation value when F=0, the field N3 picture signal when F=−1, and the field N1 picture signal when F=1, thus generating a pixel value of the scan line to be interpolated.

A description will be given below of the reason why the picture signal processing device configured as described above can detect a telecine material having an arbitrary pulldown sequence using a common circuit. A description will also be given of the reason why the same device is resistant to erroneous de-interlacing even in the presence of an edit point or hybrid material while offering quick detection response without sacrificing film detection accuracy.

First, a description will be given of the reason why the film detection circuit 28 according to the present second embodiment can detect a telecine material having an arbitrary pulldown sequence.

In a telecine material, at least two of the three consecutive fields are derived from the same film frame. The film frames are different in image content from one another when one of m1 and m2 is close to 0 and the other larger than 0. As a result, Z is close to 0. One of J1 and J2 is close to 0, and the other larger than 0.

For this reason, when the input picture signal is a telecine material, it is highly likely that Z<Za holds and that the output value of the first threshold circuit 37 is 1. Similarly, if J1 and J2 differ significantly from each other, it is highly likely that J1≧k×J2 or J2≧λ×J1 holds and that the output value of the second threshold circuit 38 is non-0.

On the other hand, when the film frames are identical in image content to one another, M=0 for all pixels. Therefore, Z=J1=J2=0. As a result, the film determination result F=0. However, a still image of a telecine material is not distinguishable from that of a video material. Therefore, such a determination does not practically pose any problem.

In fact, when the input signal is a still image, selection of any of the three options, namely, the output value of the interpolation circuit 41 and the field N1 and N3 picture signals, will ensure proper interpolation. Therefore, the value F may be arbitrary, and film detection is not particularly required.

As a result, we can say that the film detection circuit 28 can detect a telecine material having an arbitrary pulldown sequence.

A description will be given next of the reason why the film detection circuit 28 according to the second embodiment can handle film detection with high accuracy.

The motion judder j1 detected by the first motion judder detection circuit 34 is large when there is a picture motion between frames but no picture motion between the current and next fields.

On the other hand, the motion judder j2 detected by the second motion judder detection circuit 35 is large when there is a picture motion between frames but no picture motion between the current and previous fields. The presence of a picture motion between frames with no motion between fields is a phenomenon typical of a telecine material. This hardly occurs in a video material. As a result, high accuracy can be achieved if film detection is based on the motion judders j1 and j2.

Further, the film detection circuit 28 and de-interlacing circuit 29 according to the second embodiment can quickly handle frequent switching between telecine and video materials. This is obvious considering the fact that the determination result of the identification circuit 39 incorporated in the film determination circuit 36 is always finalized in one field after the input of a picture from the input terminal 1.

The de-interlacing circuit 29 performs de-interlacing using a picture signal delayed by one field from the input picture signal. As a result, the same circuit can perform de-interlacing using the finalized film determination result. Therefore, the same circuit can quickly change de-interlacing methods according to the status of the input picture signal even if the signal status changes frequently because of many picture edit points.

Further, the de-interlacing circuit 29 according to the second embodiment is resistant to erroneous de-interlacing even if the input picture signal is a hybrid material. The reason for this is that if the input picture signal may be a hybrid material, the film determination result F is set to 0 by the moving image determination circuit 33 so that the output value of the interpolation circuit 41 adapted to perform interpolation tailored to a video material is used as the interpolation value. At this time, the output value of the interpolation circuit 41 is also selected for the display screen area derived from a telecine material. However, the degradation in de-interlacing performance resulting from this is confined to the degradation in vertical resolution in the moving image area containing a vertical high frequency component.

On the other hand, performing de-interlacing by assuming a hybrid material to be a telecine material causes images captured at different times to be superposed one on the other. This produces a double image artifact in the moving image area, significantly degrading the de-interlacing performance.

We can say, therefore, that the de-interlacing circuit 29 according to the second embodiment is resistant to erroneous de-interlacing even for a hybrid material.

It should be noted that although the second embodiment performs film detection based on the ratio of J1 and J2, the same effects can be achieved by performing film detection based on the difference between J1 and J2.

Further, the second embodiment detects the motion judders using frame-to-frame and field-to-field picture motions. However, the motion judders may be detected using a similarity in pixel value between frames and similarities in pixel value between fields.

For example, if a similarity in pixel value between frames Q is defined to be Q=1−M and similarities in pixel value between fields q1 and q2 are respectively defined to be q1=1−m1 and q2=1−m2, the motion judders j1 and j2 can be calculated using Q, q1 and q2.

### Third Embodiment

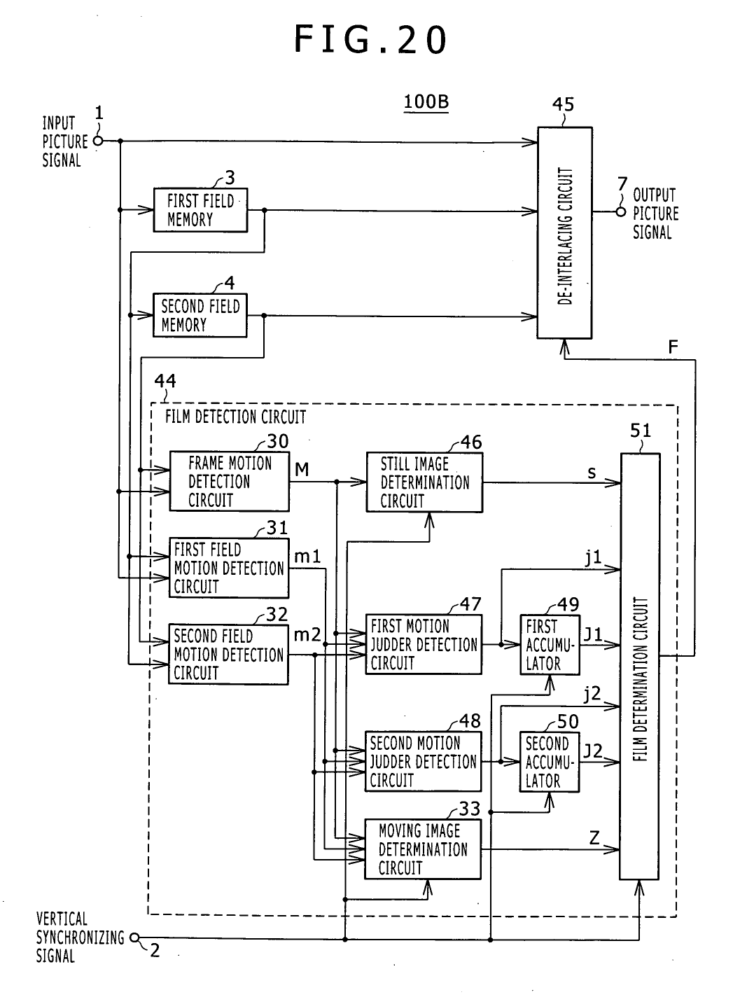

FIG. 20 is a view illustrating the overall configuration of the picture signal processing device according to a third embodiment of the present invention.

In FIG. 20, the components having the same function as those in the first and second embodiments are denoted by the same reference numerals, and a description thereof will be omitted.

A picture signal processing device 100B includes, a film detection circuit 44 adapted to determine whether the picture signal received from the input terminal 1 is an interlaced signal generated by the telecine process, and a de-interlacing circuit 45 adapted to change de-interlacing methods according to the detection result of the film detection circuit 44.

The dotted line in FIG. 20 represents the film detection circuit 44. The area enclosed by the dotted line illustrates the internal configuration of the same circuit 44. The frame motion detection circuit 30, first and second field motion detection circuits 31 and 32 and moving image determination circuit 33 are the same as those according to the second embodiment.

The film detection circuit 44 includes, a still image determination circuit 46 adapted to detect that there is no picture motion between frames using the frame-to-frame picture motion detected by the frame motion detection circuit 30, a first motion judder detection circuit 47 adapted to detect a motion judder using the detection results of the frame motion detection circuit 30 and first and second field motion detection circuits 31 and 32, a second motion judder detection circuit 48 adapted to detect a motion judder using the detection results of the frame motion detection circuit 30 and first and second field motion detection circuits 31 and 32, a first accumulator 49 adapted to accumulate the detection result of the first motion judder detection circuit 47 in the spatial direction, a second accumulator 50 adapted to accumulate the detection result of the second motion judder detection circuit 48 in the spatial direction, and a film determination circuit 51 adapted to determine the probability that the picture signal received from the input terminal 1 is an interlaced signal generated by the telecine process. The determination results of the moving image determination circuit 33 and still image determination circuit 46, the detection results of the first and second motion judder detection circuits 47 and 48 and the accumulation results of the first and second accumulators 49 and 50 are used to determine the probability.

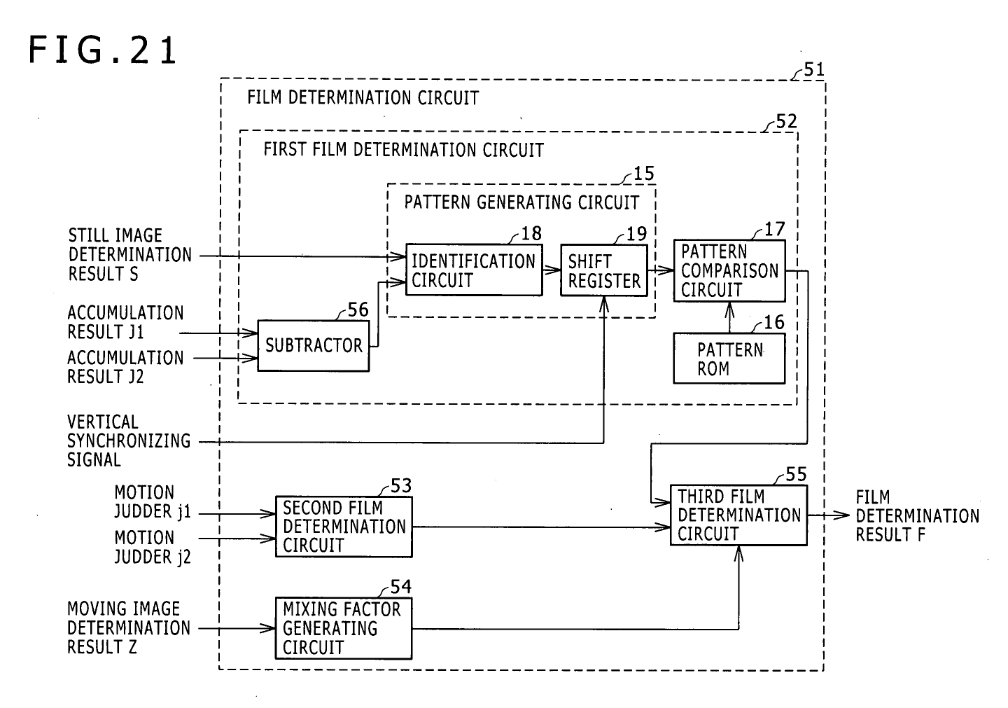

FIG. 21 is a view illustrating the internal configuration of the film determination circuit 51 according to the third embodiment.

The film determination circuit 51 includes three film determination circuits.

As illustrated in FIG. 21, the film detection circuit 51 includes a first film determination circuit 52 adapted to determine the probability that the picture signal received from the input terminal 1 is an interlaced signal generated by the telecine process for a global display screen area. The determination result of the still image determination circuit 46 and the accumulation results of the first and second accumulators 49 and 50 are used to determine the probability. The film detection circuit 51 further includes a second film determination circuit 53 adapted to determine the probability that the picture signal received from the input terminal 1 is an interlaced signal generated by the telecine process for a local display screen area. The detection results of the first and second motion judder detection circuits 47 and 48 are used to determine the probability. The film detection circuit 51 still further includes a mixing factor generating circuit 54 adapted to generate a mixing factor using the determination result of the moving image determination circuit 33. The film detection circuit 51 still further includes a third film determination circuit 55 adapted to produce a final film determination result by weighting the determination results of the first and second film determination circuits 52 and 53 by the mixing factor generated by the mixing factor generating circuit 54.

The determination result of the third film determination circuit 55 is output to the de-interlacing circuit 45 as the determination result F of the film determination circuit 51.

It should be noted that the first film determination circuit 52 has the same configuration as the film determination circuit 12 according to the first embodiment shown in FIG. 2 except that a subtractor 56 is provided which is adapted to find the difference in accumulation result between the first and second accumulators 49 and 50.

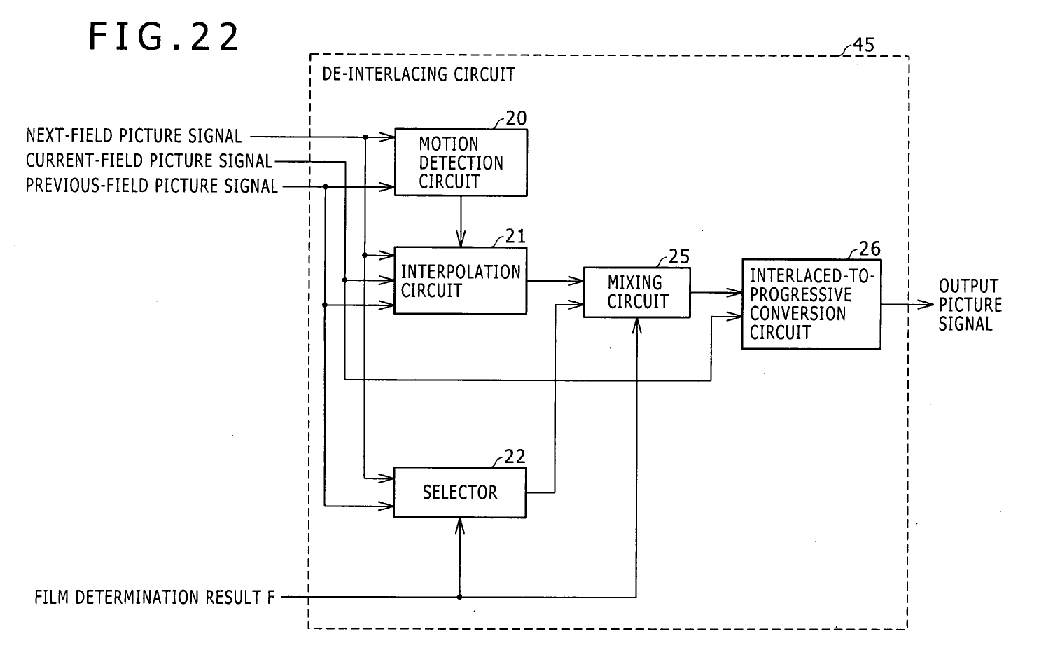

FIG. 22 is a view illustrating the internal configuration of the de-interlacing circuit 45 according to the present third embodiment.

The de-interlacing circuit 45 is almost identical in internal configuration to the de-interlacing circuit 6 according to the first embodiment shown in FIG. 3 except that the adder 23 and mixing factor generating circuit 24 are not provided.

A description will be given below of the picture signal processing device according to the third embodiment.

The still image determination circuit 46 calculates s=1−M using the frame-to-frame picture motion M detected by the frame motion detection circuit 30 to find the total sum S of s over the entire display screen.

The first motion judder detection circuit 47 calculates j1 as follows using the frame-to-frame picture motion M detected by the frame motion detection circuit 30 and the field-to-field motions m1 and m2 detected respectively by the first and second field motion detection circuits 31 and 32:

j1=M×(1−m1)×(1+m2)/2

j1 takes on the maximum value when M=1, m1=0 and m2=1. These conditions are satisfied when there is a large picture motion between frames and between the current and previous fields and when there is no picture motion between the current and next fields.

Similarly, the second motion judder detection circuit 48 calculates j2 as follows using M, m1 and m2.

j2=M×(1−m2)×(1+m1)/2

j2 takes on the maximum value when M=1, m1=1 and m2=0. These conditions are satisfied when there is a large picture motion between frames and between the current and next fields and if there is no picture motion between the current and previous fields.

The first accumulator 49 outputs the value J1, obtained by accumulating the value j1 in the spatial direction, to the film determination circuit 51. The value J1 is reset to 0 each time a reference edge of a vertical synchronizing signal is received from the input terminal 2.

Similarly, the second accumulator 50 outputs the value J2, obtained by accumulating the value j2 in the spatial direction, to the film determination circuit 51. The value J2 is reset to 0 each time a reference edge of a vertical synchronizing signal is received from the input terminal 2.

The first film determination circuit 52 incorporated in the film determination circuit 51 feeds J2−J1, which is the subtraction result of the subtractor 56, to the identification circuit 18. The identification circuit 18 identifies whether the input signal is a telecine or video material using the subtraction result J2−J1 rather than the accumulation result J of the accumulator 14 according to the first embodiment. The pattern comparison circuit 17 operates exactly in the same manner as in the first embodiment and outputs −β or γ. The output value of the pattern comparison circuit 17 is fed to the third film determination circuit 55 as the determination result of the first film determination circuit 52.

Hereinafter, the determination result of the first film determination circuit 52 will be written as F1.

When F1>0, the current and previous fields are highly likely to be derived from the same film frame. When F1<0, the current and next fields are highly likely to be derived from the same film frame. When F=0, the input picture signal is highly likely to be a video material.

The second film determination circuit 53 determines on a pixel-by-pixel basis whether the input picture signal is a telecine material using the detection results j1 and j2 of the first and second motion judder detection circuits 47 and 48.

More specifically, we assume the value obtained by multiplying j2−j1 by a positive constant to be the film determination result. Hereinafter, the determination result of the second film determination circuit 53 will be written as F2.

When F2>0, the current and previous fields are highly likely to be derived from the same film frame. When F2<0, the current and next fields are highly likely to be derived from the same film frame.

The mixing factor generating circuit 54 generates a mixing factor k3 using the detection result Z of the moving image determination circuit. Here, we assume the value obtained by transforming Z by a monotonically non-decreasing function to be k3.

The third film determination circuit 55 outputs the absolute value and sign of F3 obtained by the following function to the de-interlacing circuit 45 as the final film determination result F.

F3=(1−k3)×F1+k3×F2

The value k3 is monotonically non-decreasing with respect to Z. As a result, if Z is large and the input picture signal is highly likely to be a hybrid material, the value F3 is strongly affected by the value F2. On the other hand, if Z is small and the input picture signal is unlikely to be a hybrid material, the value F3 is strongly affected by the value F1.

The de-interlacing circuit 45 operates exactly in the same manner as the de-interlacing circuit 6 according to the first embodiment except that the de-interlacing circuit 45 uses the film determination circuit F of the film detection circuit 44 rather than the value F+j obtained by the adder 23 according to the first embodiment.

That is, when F3<0, the selector 22 selects the previous-field picture signal using the sign of F3 which makes up the film determination result F. When F3≧0, the selector 22 selects the next-field picture signal. The mixing circuit 25 determines the pixel value of the scan line to be interpolated using the absolute value of F3 as the mixing factor k2.

The third embodiment offers the same effects as the first embodiment and allows for more appropriate de-interlacing for a hybrid material than the first embodiment. These features will be described below.

The first film determination circuit 52 according to the third embodiment includes almost the same circuit components as the film determination circuit 12 according to the first embodiment.

Therefore, the film detection circuit 44 according to the third embodiment can detect a telecine material having an arbitrary pulldown sequence. This makes it possible to relate the film detection result quickly to the switching of the input between telecine and video materials.

Further, both the first and second motion judder detection circuits 47 and 48 according to the third embodiment detect a pixel where there is a picture motion between frames but no picture motion between the current and previous fields. This is a phenomenon typical of a telecine material. As a result, the same circuits 47 and 48 are capable of film detection with high accuracy.

Still further, in the third embodiment, the first film determination circuit 52 performs global film detection whereas the second film determination circuit 53 performs local film detection on a pixel-by-pixel basis. This makes it possible to select a proper de-interlacing method for each display screen area even if a hybrid material is input.

In particular, the film determination circuit 51 according to the third embodiment changes the weighting of global and local film detection according to the determination result Z of the moving image determination circuit. If the input picture signal is highly likely to be a hybrid material, the film detection circuit 51 operates so that the result of local film detection has a stronger impact. This prevents failure to detect the display screen areas derived from a video material.

On the other hand, if the input picture signal is unlikely to be a hybrid material, the film detection circuit 51 operates so that the result of global film detection has a stronger impact. This prevents erroneous determination of a telecine material containing many vertical high frequency components to be a video material.

It should be noted that although the second film determination circuit 53 uses the motion judders j1 and j2 in the third embodiment, the field-to-field motions m1 and m2 may be used rather than j1 and j2.

If the input picture signal does not contain any vertical high frequency component, the current and previous fields are highly likely to be derived from the same film frame when m1−m2>0. The current and next fields are highly likely to be derived from the same film frame when m1−m2<0.

### Fourth Embodiment

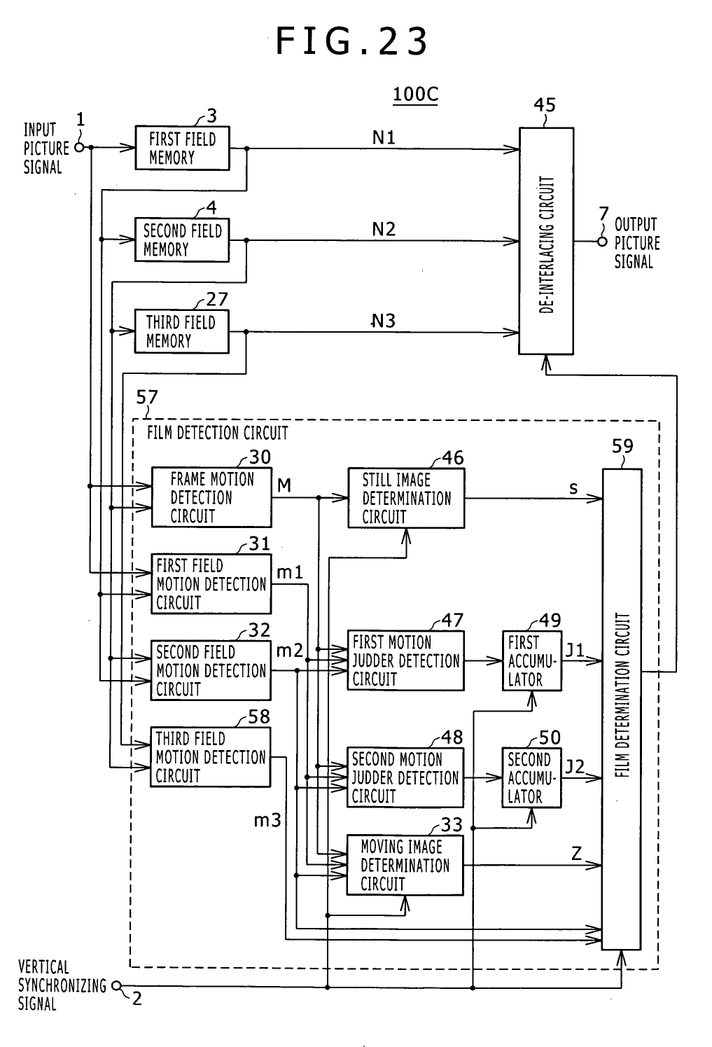

FIG. 23 is a view illustrating the overall configuration of the picture signal processing device according to a fourth embodiment of the present invention.

In FIG. 23, the components having the same function as those in the first and third embodiments are denoted by the same reference numerals, and a description thereof will be omitted.

A picture signal processing device 100C according to the fourth embodiment includes the third field memory 27 adapted to delay the picture signal received from the input terminal 1 by three fields as with the picture signal processing device according to the second embodiment. The fourth embodiment differs from the third embodiment in that the de-interlacing circuit 45 uses the fields N1, N2 and N3 rather than the fields N0, N1 and N2 for de-interlacing.

In addition to the configuration of the picture signal processing device according to the third embodiment, the picture signal processing device 100C according to the fourth embodiment includes a film detection circuit 57 adapted to determine whether the picture signal received from the input terminal 1 is an interlaced signal generated by the telecine process. The picture signal processing device 100C further includes a third field motion detection circuit 58 adapted to detect a field-to-field picture motion using the output picture signals of the second and third field memories 4 and 27. The picture signal processing device 100C still further includes a film determination circuit 59 adapted to determine the probability that the picture signal received from the input terminal 1 is an interlaced signal generated by the telecine process. The accumulation results of the first and second accumulators 49 and 50 and the detection results of the second and third field motion detection circuits 32 and 58 are used to determine the probability.

Except for the above, the picture signal processing device 100C is identical in configuration to the picture signal processing device according to the third embodiment.

Hereinafter, the field-to-field picture motion detected by the third field motion detection circuit 58 will be written as m3.

Although identical in internal configuration to the film determination circuit 51 according to the third embodiment shown in FIG. 21, the film determination circuit 59 differs from the circuit 51 in that the second film determination circuit 53 uses the field-to-field motions m2 and m3 rather than the motion judders j1 and j2.

Further, the pattern comparison circuit 17 outputs γ rather than −β when the pattern represented by the shift register 19 matches the pattern PTN1 or PTN2. The pattern comparison circuit 17 outputs −β rather than γ when the pattern represented by the shift register 19 matches the pattern PTN3 or PTN4. This is intended to accommodate the fact that the three fields used by the de-interlacing circuit 45 are each delayed by one field from those used in the third embodiment.

As described above, the determination result F of the film determination circuit 59 is positive when the fields N1 and N2 are derived from the same film frame. The determination result F is negative when the fields N2 and N3 are derived from the same film frame.

The picture signal processing device 100C according to the fourth embodiment is configured so that the picture signals delayed by one or more fields are used for de-interlacing. This has been done in consideration of the fact that at least one field is required before the accumulation results of the first and second accumulators 49 and 50 are finalized.

The third embodiment detects that the fields N2 and N3 are derived from the same film frame when F>0. Based on this, the third embodiment estimates that the fields N0 and N1 are derived from the same film frame.

In contrast, the fourth embodiment does not need to make such an estimation because the fields N1, N2 and N3 are used for de-interlacing. This ensures more reliable film detection.

Although cases have been described in the first to fourth embodiments in which film detection and de-interlacing are performed by hardware, the present invention is not limited thereto. Alternatively, film detection and de-interlacing may be performed by software.

As described above, the first to fourth embodiments are configured to perform film detection by detecting an image area where there is a picture motion between frames but no picture motion between fields. This makes it possible to detect a telecine material having an arbitrary pulldown sequence, providing high film detection accuracy and quick response at the same time.

Further, the first to fourth embodiments are configured to perform film detection for both global and local screen areas. This makes it possible to determine, for each screen area, whether the input picture signal is a telecine or video material.

It should be understood by those skilled in the art that various modifications, combinations, sub-combinations and alterations may occur depending on design requirements and other factors insofar as they are within the scope of the appended claims or the equivalents thereof.

What is claimed is:

1. A film detection device for determining whether an input picture signal is an interlaced signal generated by the telecine process, the film detection device comprising:
frame motion detection means for detecting, as a scalar or vector value, a frame-to-frame picture motion between previous and next fields, the previous field being a field preceding a current field, and the next field being a field succeeding the current field;
field motion detection means for detecting, as a scalar or vector value, a field-to-field picture motion between the current and previous or next fields;
motion judder detection means for calculating the probability that there is a picture motion between frames while there is no picture motion between fields using at least the detection results of the frame motion detection means and field motion detection means; and
film determination means for calculating the probability that the input picture signal is an interlaced signal generated by the telecine process using at least the detection result of the motion judder detection means.

2. The film detection device of claim 1, wherein
the motion judder detection means calculate the probability that there is a picture motion between frames while there is no picture motion between fields using a given transform function, wherein
the absolute value of the given transform function is maximal when the field-to-field picture motion is 0 or equal to the frame-to-frame picture motion if variables other than the field-to-field picture motion remain constant, and wherein
at least the absolute value of the given transform function when the field-to-field picture motion is 0 or equal to the frame-to-frame picture motion is monotonically non-decreasing with respect to the magnitude of the frame-to-frame picture motion.

3. The film detection device of claim 1, wherein
the detection result of the motion judder detection means differs in sign between when it is relatively more probable that there is a picture motion between frames while there is no picture motion between the current and previous fields and when it is relatively more probable that there is a picture motion between frames while there is no picture motion between the current and next fields.

4. A film detection device for determining whether an input picture signal is an interlaced signal generated by the telecine process, the film detection device comprising:
frame motion detection means for detecting, as a scalar or vector value, a frame-to-frame picture motion between previous and next fields, the previous field being a field preceding a current field, and the next field being a field succeeding the current field;
first field motion detection means for detecting, as a scalar or vector value, a field-to-field picture motion between the current and next fields;
second field motion detection means for detecting, as a scalar or vector value, a field-to-field picture motion between the current and previous fields;
first motion judder detection means for calculating the probability that there is a picture motion between frames while there is no picture motion between fields using at least the detection results of the frame motion detection means and first field motion detection means;
second motion judder detection means for calculating the probability that there is a picture motion between frames while there is no picture motion between fields using at least the detection results of the frame motion detection means and second field motion detection means; and
film determination means for calculating the probability that the input picture signal is an interlaced signal generated by the telecine process using at least the detection results of the first and second motion judder detection means.

5. The film detection device of claim 4, wherein
the first motion judder detection means calculate the probability that there is a picture motion between frames while there is no picture motion between fields using a first transform function, wherein
the second motion judder detection means calculate the probability that there is a picture motion between frames while there is no picture motion between fields using a second transform function, wherein
the absolute value of the first transform function is monotonically non-decreasing with respect to the magnitude of the frame-to-frame picture motion and monotonically non-increasing with respect to the magnitude of the field-to-field picture motion detected by the first field motion detection means, and wherein
the absolute value of the second transform function is monotonically non-decreasing with respect to the magnitude of the frame-to-frame picture motion and monotonically non-increasing with respect to the magnitude of the field-to-field picture motion detected by the second field motion detection means.

6. The film detection device of claim 4, wherein
the film determination means calculate the probability that the input picture signal is an interlaced signal generated by the telecine process according to the ratio of or difference between the detection results of the first and second motion judder detection means.

7. The film detection device of claim 1, wherein
the motion judder detection means comprise:
calculation means adapted to calculate the probability that there is a picture motion between frames while there is no picture motion between fields for a first image area using at least the detection results of the frame motion detection means and field motion detection means; and
accumulation means adapted to calculate the probability that there is a picture motion between frames while there is no picture motion between fields for a second image area which is relatively larger than the first image area by accumulating the calculation result of the calculation means, and wherein
the film determination means use only the accumulation result of the accumulation means or both the calculation result of the calculation means and the accumulation result of the accumulation means as the detection result of the motion judder detection means.

8. A film detection device for determining whether an input picture signal is an interlaced signal generated by the telecine process, the film detection device comprising:
first delaying means adapted to delay the input picture signal by one field;
second delaying means adapted to delay the input picture signal by two fields;
frame motion detection means for detecting, as a scalar or vector value, a frame-to-frame picture motion using the input picture signal and an output picture signal of the second delaying means;
first field motion detection means for detecting, as a scalar or vector value, a field-to-field picture motion using the input picture signal and an output picture signal of the first delaying means;
second field motion detection means for detecting, as a scalar or vector value, a field-to-field picture motion using the input picture signal and the output picture signal of the second delaying means;
first motion judder detection means for calculating the probability that there is a picture motion between frames while there is no picture motion between fields using at least the detection results of the frame motion detection means and first field motion detection means;
second motion judder detection means for calculating the probability that there is a picture motion between frames while there is no picture motion between fields using at least the detection results of the frame motion detection means and second field motion detection means;
first accumulation means for accumulating the detection result of the first motion judder detection means in the spatial direction;
second accumulation means for accumulating the detection result of the second motion judder detection means in the spatial direction;
first film determination means for determining the probability that the input picture signal is an interlaced signal generated by the telecine process for a global image area using at least the accumulation results of the first and second accumulation means; and
second film determination means for determining the probability that the input picture signal is an interlaced signal generated by the telecine process for a local image area which is part of the global image area using at least the detection result of the first field motion detection means or first motion judder detection means and the detection result of the second field motion detection means or second motion judder detection means.

9. A film detection device for determining whether an input picture signal is an interlaced signal generated by the telecine process, the film detection device comprising:
first delaying means for delaying the input picture signal by one field;
second delaying means for delaying the input picture signal by two fields;
third delaying means for delaying the input picture signal by three fields;
frame motion detection means for detecting, as a scalar or vector value, a frame-to-frame picture motion using output picture signals of the first and third delaying means;
first field motion detection means for detecting, as a scalar or vector value, a field-to-field picture motion using the input picture signal and the output picture signal of the first delaying means;
second field motion detection means for detecting, as a scalar or vector value, a field-to-field picture motion using the output picture signal of the first delaying means and an output picture signal of the second delaying means;
third field motion detection means for detecting, as a scalar or vector value, a field-to-field picture motion using the output picture signals of the second and third delaying means;
first motion judder detection means for calculating the probability that there is a picture motion between frames while there is no picture motion between fields using at least the detection results of the frame motion detection means and first field motion detection means;
second motion judder detection means for calculating the probability that there is a picture motion between frames while there is no picture motion between fields using at least the detection results of the frame motion detection means and second field motion detection means;
first accumulation means for accumulating the detection result of the first motion judder detection means in the spatial direction;
second accumulation means for accumulating the detection result of the second motion judder detection means in the spatial direction;
first film determination means for determining the probability that the input picture signal is an interlaced signal generated by the telecine process for a global image area using at least the accumulation results of the first and second accumulation means; and
second film determination means for determining the probability that the input picture signal is an interlaced signal generated by the telecine process for a local image area which is part of the global image area using at least the detection results of the second and third field motion detection means.

10. The film detection device of claim 1, further comprising:
still image determination means for determining the probability that there is no picture motion between frames using the detection result of the frame motion detection means, wherein
the film determination means change the probability that the input picture signal is an interlaced signal generated by the telecine process according to the determination result of the still image determination means.

11. The film detection device of claim 1, wherein
the film determination means comprise:
pattern generating means for generating a finite and discrete number of patterns using the time series of one or more detection results of the motion judder detection means;
pattern storage means for storing one or more patterns to be compared with a pattern generated by the pattern generating means; and
pattern comparison means for increasing the probability that the input picture signal is an interlaced signal generated by the telecine process when the pattern generated by the pattern generating means matches one of the patterns stored in the pattern storage means.

12. The film detection device of claim 10, wherein
the film determination means comprise:
pattern generating means for generating a finite and discrete number of patterns using the time series of one or more detection results of the motion judder detection means and the detection result of the still image determination means;
pattern storage means for storing one or more patterns to be compared with a pattern generated by the pattern generating means; and
pattern comparison means for increasing the probability that the input picture signal is an interlaced signal generated by the telecine process when the pattern generated by the pattern generating means matches one of the patterns stored in the pattern storage means.

13. The film detection device of claims 1, further comprising:
moving image determination means for determining the probability that there is a picture motion between fields for two consecutive fields using the frame-to-frame and field-to-field picture motions, wherein
the film determination means change the probability that the input picture signal is an interlaced signal generated by the telecine process according to the determination result of the moving image determination means.

14. A picture signal processing device for converting an input picture signal, which is an interlaced signal, into a progressive signal, the picture signal processing device comprising:
frame motion detection means for detecting, as a scalar or vector value, a frame-to-frame picture motion between previous and next fields, the previous field being a field preceding a current field, and the next field being a field succeeding the current field;
field motion detection means for detecting, as a scalar or vector value, a field-to-field picture motion between the current and previous or next fields;
motion judder detection means for calculating the probability that there is a picture motion between frames while there is no picture motion between fields using at least the detection results of the frame motion detection means and field motion detection means; and
de-interlacing means for changing methods to convert the input picture signal into a progressive signal at least according to the detection result of the motion judder detection means.

15. A picture signal processing device for converting an input picture signal, which is an interlaced signal, into a progressive signal, the picture signal processing device at least comprising:
the film detection device of claim 1, and
de-interlacing means for converting the input signal into a progressive signal, wherein
the de-interlacing means change methods to convert the input picture signal into a progressive signal according to the determination result of the film determination means.

16. A film detection method for determining whether an input picture signal is an interlaced signal generated by the telecine process, the film detection method comprising the steps of:
detecting, as a scalar or vector value, a frame-to-frame picture motion M between previous and next fields, the previous field being a field preceding a current field, and the next field being a field succeeding the current field;
detecting, as a scalar or vector value, a field-to-field picture motion m between the current and previous or next fields;
calculating a probability J that there is a picture motion between frames while there is no picture motion between fields using at least the frame-to-frame picture motion M and field-to-field picture motion m; and
calculating the probability that the input picture signal is an interlaced signal generated by the telecine process using at least the probability J.

17. A film detection method for determining whether an input picture signal is an interlaced signal generated by the telecine process, the film detection method comprising the steps of:
detecting, as a scalar or vector value, a frame-to-frame picture motion M between previous and next fields, the previous field being a field preceding a current field, and the next field being a field succeeding the current field;
detecting, as a scalar or vector value, a field-to-field picture motion m1 between the current and next fields;
detecting, as a scalar or vector value, a field-to-field picture motion m2 between the current and previous fields;
calculating a probability J1 that there is a picture motion between frames while there is no picture motion between fields using at least the frame-to-frame picture motion M and field-to-field picture motion m1;
calculating a probability J2 that there is a picture motion between frames while there is no picture motion between fields using at least the frame-to-frame picture motion M and field-to-field picture motion m2; and
calculating the probability that the input picture signal is an interlaced signal generated by the telecine process using at least the probabilities J1 and J2.

18. A film detection method for determining whether an input picture signal is an interlaced signal generated by the telecine process, the film detection method comprising the steps of:
delaying the input picture signal by one field to obtain a one-field delayed signal;
delaying the input picture signal by two fields to obtain a two-field delayed signal;
detecting, as a scalar or vector value, a frame-to-frame picture motion M using the input picture signal and two-field delayed signal;
detecting, as a scalar or vector value, a field-to-field picture motion m1 using the input picture signal and one-field delayed signal;
detecting, as a scalar or vector value, a field-to-field picture motion m2 using the one-field and two-field delayed signals;
calculating a probability j1 that there is a picture motion between frames while there is no picture motion between fields using at least the frame-to-frame picture motion M and field-to-field picture motion m1;
calculating a probability j2 that there is a picture motion between frames while there is no picture motion between fields using at least the frame-to-frame picture motion M and field-to-field picture motion m2;
accumulating the probability j1 in the spatial direction to obtain an accumulated sum J1;
accumulating the probability j2 in the spatial direction to obtain an accumulated sum J2;
determining the probability that the input picture signal is an interlaced signal generated by the telecine process for a global image area using at least the accumulated sums J1 and J2; and
determining the probability that the input picture signal is an interlaced signal generated by the telecine process for a local image area which is part of the global image area using at least the field-to-field picture motion m1 or probability j1 and the field-to-field picture motion m2 or probability j2.

19. A film detection method for determining whether an input picture signal is an interlaced signal generated by the telecine process, the film detection method comprising the steps of:
delaying the input picture signal by one field to obtain a one-field delayed signal;
delaying the input picture signal by two fields to obtain a two-field delayed signal;
delaying the input picture signal by three fields to obtain a three-field delayed signal;
detecting, as a scalar or vector value, a frame-to-frame picture motion M using the one-field and three-field delayed signals;
detecting, as a scalar or vector value, a field-to-field picture motion m1 using the input picture signal and one-field delayed signal;
detecting, as a scalar or vector value, a field-to-field picture motion m2 using the one-field and two-field delayed signals;
detecting, as a scalar or vector value, a field-to-field picture motion m3 using the two-field and three-field delayed signals;
calculating a probability j1 that there is a picture motion between frames while there is no picture motion between fields using at least the frame-to-frame picture motion M and field-to-field picture motion m1;
calculating a probability j2 that there is a picture motion between frames while there is no picture motion between fields using at least the frame-to-frame picture motion M and field-to-field picture motion m2;
accumulating the probability j1 in the spatial direction to obtain an accumulated sum J1;
accumulating the probability j2 in the spatial direction to obtain an accumulated sum J2;
determining the probability that the input picture signal is an interlaced signal generated by the telecine process for a global image area using at least the accumulated sums J1 and J2; and
determining the probability that the input picture signal is an interlaced signal generated by the telecine process for a local image area which is part of the global image area using at least the field-to-field picture motions m2 and m3.

20. A picture signal processing method for converting an input picture signal, which is an interlaced signal, into a progressive signal, the picture signal processing method comprising the steps of:
detecting, as a scalar or vector value, a frame-to-frame picture motion M between previous and next fields, the previous field being a field preceding a current field, and the next field being a field succeeding the current field;
detecting, as a scalar or vector value, a field-to-field picture motion m between the current and previous or next fields;
calculating a probability j that there is a picture motion between frames while there is no picture motion between fields using at least the frame-to-frame picture motion M and field-to-field picture motion m; and
changing methods to convert the input picture signal into a progressive signal at least according to the probability j.

21. A picture signal processing method for converting an input picture signal, which is an interlaced signal, into a progressive signal, the picture signal processing method comprising changing methods to convert the input picture signal into a progressive signal according to the detection result obtained by using the film detection method of claim 16.

22. A film detection device for determining whether an input picture signal is an interlaced signal generated by the telecine process, the film detection device comprising:
a frame motion detection section configured to detect, as a scalar or vector value, a frame-to-frame picture motion between previous and next fields, the previous field being a field preceding a current field, and the next field being a field succeeding the current field;
a field motion detection section configured to detect, as a scalar or vector value, a field-to-field picture motion between the current and previous or next fields;
a motion judder detection section configured to calculate the probability that there is a picture motion between frames while there is no picture motion between fields using at least the detection results of the frame motion detection section and field motion detection section; and
a film determination configured to calculate the probability that the input picture signal is an interlaced signal generated by the telecine process using at least the detection result of the motion judder detection section.

23. A film detection device for determining whether an input picture signal is an interlaced signal generated by the telecine process, the film detection device comprising:
a frame motion detection configured to detecte, as a scalar or vector value, a frame-to-frame picture motion between previous and next fields, the previous field being a field preceding a current field, and the next field being a field succeeding the current field;
a first field motion detection configured to detect, as a scalar or vector value, a field-to-field picture motion between the current and next fields;
a second field motion detection configured to detect, as a scalar or vector value, a field-to-field picture motion between the current and previous fields;
a first motion judder detection configured to calculate the probability that there is a picture motion between frames while there is no picture motion between fields using at least the detection results of the frame motion detection section and first field motion detection section;
a second motion judder detection configured to calculate the probability that there is a picture motion between frames while there is no picture motion between fields using at least the detection results of the frame motion detection section and second field motion detection section; and
a film determination configured to calculate the probability that the input picture signal is an interlaced signal generated by the telecine process using at least the detection results of the first and second motion judder detection section.

24. A film detection device for determining whether an input picture signal is an interlaced signal generated by the telecine process, the film detection device comprising:
a first delaying section adapted to delay the input picture signal by one field;
a second delaying section adapted to delay the input picture signal by two fields;
a frame motion detection configured to detect, as a scalar or vector value, a frame-to-frame picture motion using the input picture signal and an output picture signal of the second delaying section;
a first field motion detection configured to detect, as a scalar or vector value, a field-to-field picture motion using the input picture signal and an output picture signal of the first delaying section;
a second field motion detection configured to detect, as a scalar or vector value, a field-to-field picture motion using the input picture signal and the output picture signal of the second delaying section;
a first motion judder detection configured to calculate the probability that there is a picture motion between frames while there is no picture motion between fields using at least the detection results of the frame motion detection section and first field motion detection section;
a second motion judder detection configured to calculate the probability that there is a picture motion between frames while there is no picture motion between fields using at least the detection results of the frame motion detection section and second field motion detection section;
a first accumulation configured to accumulate the detection result of the first motion judder detection section in the spatial direction;
a second accumulation configured to accumulate the detection result of the second motion judder detection section in the spatial direction;
a first film determination configured to determine the probability that the input picture signal is an interlaced signal generated by the telecine process for a global image area using at least the accumulation results of the first and second accumulation section; and
a second film determination configured to determine the probability that the input picture signal is an interlaced signal generated by the telecine process for a local image area which is part of the global image area using at least the detection result of the first field motion detection section or first motion judder detection section and the detection result of the second field motion detection section or second motion judder detection section.

25. A film detection device for determining whether an input picture signal is an interlaced signal generated by the telecine process, the film detection device comprising:
a first delaying configured to delay the input picture signal by one field;
a second delaying configured to delay the input picture signal by two fields;
a third delaying configured to delay the input picture signal by three fields;
a frame motion detection configured to detect, as a scalar or vector value, a frame-to-frame picture motion using output picture signals of the first and third delaying section;
a first field motion detection configured to detect, as a scalar or vector value, a field-to-field picture motion using the input picture signal and the output picture signal of the first delaying section;
a second field motion detection configured to detect, as a scalar or vector value, a field-to-field picture motion using the output picture signal of the first delaying section and an output picture signal of the second delaying section;
a third field motion detection configured to detect, as a scalar or vector value, a field-to-field picture motion using the output picture signals of the second and third delaying section;
a first motion judder detection configured to calculate the probability that there is a picture motion between frames while there is no picture motion between fields using at least the detection results of the frame motion detection section and first field motion detection section;
a second motion judder detection configured to calculate the probability that there is a picture motion between frames while there is no picture motion between fields using at least the detection results of the frame motion detection section and second field motion detection section;
a first accumulation configured to accumulate the detection result of the first motion judder detection section in the spatial direction;
a second accumulation configured to accumulate the detection result of the second motion judder detection section in the spatial direction;
a first film determination configured to determine the probability that the input picture signal is an interlaced signal generated by the telecine process for a global image area using at least the accumulation results of the first and second accumulation section; and
a second film determination configured to determine the probability that the input picture signal is an interlaced signal generated by the telecine process for a local image area which is part of the global image area using at least the detection results of the second and third field motion detection section.

26. A picture signal processing device for converting an input picture signal, which is an interlaced signal, into a progressive signal, the picture signal processing device comprising:
a frame motion detection configured to detect, as a scalar or vector value, a frame-to-frame picture motion between previous and next fields, the previous field being a field preceding a current field, and the next field being a field succeeding the current field;
a field motion detection configured to detect, as a scalar or vector value, a field-to-field picture motion between the current and previous or next fields;
a motion judder detection configured to calculate the probability that there is a picture motion between frames while there is no picture motion between fields using at least the detection results of the frame motion detection section and field motion detection section; and
a de-interlacing configured to change methods to convert the input picture signal into a progressive signal at least according to the detection result of the motion judder detection section.
